(19) United States
(12) Patent Application Publication
(10) Pub. No.: US 2021/0179223 A1
(43) Pub. Date: Jun. 17, 2021

(54) USER INTERACTION AND VISUAL FEEDBACK SYSTEM FOR BIKES

(71) Applicant: SPIN ELECTRIC I.K.E., Nea Ionia (GR)

(72) Inventors: Nikolaos Charalampous, Athens (GR); Pyrros Kitos, Athens (GR); Iakovos Dimitriou, Athens (GR)

(73) Assignee: SPIN ELECTRIC I.K.E., Nea Ionia (GR)

(21) Appl. No.: 17/114,757

(22) Filed: Dec. 8, 2020

Related U.S. Application Data
(60) Provisional application No. 62/946,868, filed on Dec. 11, 2019.

(51) Int. Cl. B62J 50/22; B62J 45/20; B62J 45/422; B62J 6/015; G06F 3/0488; G06F 3/01

(52) U.S. Cl. CPC B62J 50/22; B62J 45/20; B62J 45/422; G06F 3/014; G06F 3/0488; G06F 3/016; B62J 6/015

(57) ABSTRACT

A methodology and system are presented for configuring bike handbrake levers into a device for user interaction and, optionally, visual feedback with minimal destruction to the rider. A touch-sensitive surface is attached to the frontal surface of a bike handbrake lever and a light emitting surface to the posterior surface of the same bike handbrake lever. User interaction is detected and analyzed to remove input during braking and random inputs, and a visual feedback is displayed to the light emitting surface for confirmation to the rider and for alerting others. Similar operation is done for situations where external devices or applications need to provide visual feedback and guidance to the rider.

### RELATED APPLICATION

This application claims the benefit of U.S. Provisional Patent Application No. 62/946,868, filed on Dec. 11, 2019.

### BACKGROUND

### Field

The present exemplary embodiment relates to user interaction and visual indication apparatuses and systems for bicycle and motorcycle type vehicles.

### Background

Bicycles and motorcycles have been invented in the 19^{th} century and since then have been an integral part of our everyday life both for commuting and leisure. Their widespread use and success is a common sight in virtually every country. Early designs have evolved and soon reliable two and three-wheeled versions were made available. Despite the many improvements over time, the main design features of such vehicles have remained the same: a frame, a handlebar, a saddle or seat, a mechanism to convert some form of push force on a pair of pedal or other foot holds, a transmission mechanism (most often a geared one) and a brake mechanism (and a motor in motorcycles). Although other extras may be used like electric motor, lights, tachometer, trip computers, stand, antitheft device, storing compartments and baskets, etc. the previous elements are the ones universally adopted in virtually all designs.

As a result of the previous designs, a rider needs to hold on the handlebar of his vehicle and either use his feet to provide the energy to operate his bicycle or turn a gas handle on the handlebar to supply gas to the motor of his motorbike and thereby control speed of motion. To brake, the rider, according to the type of braking system of his vehicle, can use a pedal brake, or more often a hand brake, while to turn he simply has to turn the handlebar to the desired direction.

It is not uncommon for a rider to indicate his intention to turn so as to warn other vehicles and pedestrians for safety reasons. Motorbikes are usually equipped with flashing indicator lights, much like cars, which lights are operated by a switch, usually a three-position switch (Left-Off-Right), so the rider has to deflect the switch to the desired position to indicate his intended direction of turning. This operation is rather easy with some degree of discomfort and risk of potential instability as the rider deflects his finger (typically his thumb) to operate the switch, which sometimes may lead less experienced drivers to unintentionally turn the handlebar slightly and deviate the vehicle from the intended direction of movement.

Very few bicycles have turning lights (operated in much the same way as those of motorbikes). As a result, their riders either turn without a warning or release one hand from the handlebar and extend it sideways to indicate their intention to turn. Both actions bear risk. The first for not warning others and the second for causing instability to the bicycle and for causing a small or larger degree of unintentional turning which can cause an accident.

The situation gets more complicated and riskier with the use of portable devices, trip computers, mobile phones, portable music players, etc. which flood the available space of handlebars. Such devices operate autonomously and use different interfaces that add to the frustration and confusion of the rider. As a result, the rider has to think how a specific device's interface is designed before he can interact with it, while at the same time distracting his attention from the riding environment. To operate these devices, the rider has to release one of his hands from the steering wheel, and even worse, distract his attention from the road scene and look at and focus on the device he wants to operate. This is a very serious situation and a cause of numerous accidents to both bicycle and motorbike riders.

Various systems and devices have been proposed in prior art to help riders keep a stable ride and avoid distractions. Among them are switches, knobs, touch buttons and touch pads for controlling head lights, indicator lights and other devices attached to or integrated with a bicycle (including electric bicycle—e-bike) or motorbike. Other prior art references teach the use of switches etc. for controlling the operation of external to the bicycle (or motorbike) computing devices like mobile phone etc. These switches are attached to the handle (steering) bar of bicycles and motorbikes and in some cases the indicator system consisted of vibration devices to inform the rider of a certain event or haptic devices, like haptic knobs to provide him with feedback, e.g. relating to the acceptance of his input to a computing system on-board the bicycle.

Last, there are very limited references which combine user command/action capture with the feedback/information provision actions in a single device, like a haptic knob.

The discovered prior art mainly consists of add-on devices that are attached to the handlebar, the frame, and few near the pivoting edge of the hand brake lever.

The discovered prior art teaches specific implementations for specific operations and all are designed to function in a way that will require a non-significant amount of user distraction to operate them (e.g., push/pull, press or touch button at specific positions on the handlebar or the pivoting edge of the hand brake levers, etc.). In cases where the control of external devices is required, the above interaction mechanism assumes that the rider will have visual contact with the screen of the device whose operation he wants to control (i.e. he is severely distracted). So, despite the fact that prior art teaches solutions to reduce user distraction while operating the said inventions, there remains a serious problem, i.e. a significant amount of user distraction, which is of course undesirable.

There is, therefore, a need for a User Interaction (UI) mechanism that is non-distracting, easy to use so as to be adopted by riders, and versatile enough to support a large variety of operations and use scenarios.

### SUMMARY

A methodology and system are presented for configuring 2, 3, or 4-cycle bike brake levers into a device for user interaction and, optionally, visual feedback.

In a first embodiment, a touch-sensitive strip is attached to the frontal surface of a bike brake lever. The user can touch the lever to either initiate a braking action or to interact with the system or with external devices and applications. Electronics and software on the lever capture, analyze and interpret the user's input and communicate with external devices and applications without distracting the user.

In a second embodiment, a touch-sensitive strip is attached to the frontal surface of a bike brake lever. The user can touch the lever to either initiate a braking action or to interact with the system or with external devices and applications. A light emitting surface is attached to the back surface of the lever. The light emitting surface is configured to produce visual feedback associated with data received from the bike, or from the external devices and applications, or associated with the user interaction that is captured by the touch sensitive surface. The combination of touch UI and visual feedback are easy to use while not distracting the user from the riding task and the environment. The proposed system can be used for indicating turning so that turn indicators are reproduced at the light emitting surface, adjusting volume, indicating battery lever, interfacing with a navigation application or system where the visual feedback indicates to the rider when and where to turn while using the same visual information as indication to cyclists and motorists behind, thereby also increasing road safety. Other use scenarios are implemented with the proposed system. Special software is used to differentiate between accidental/random user touch and real interaction gestures. Additional hardware elements like buttons and sensors may be attached on the lever to support the operation of the present system and help better differentiate between user interaction and braking.

In a third exemplary embodiment, a touch sensitive surface and associated electronics are integrated with the lever and are used as a single device and not as an add-on to existing levers.

In a fourth exemplary embodiment, a touch sensitive and a light producing surfaces and associated electronics are integrated with the lever and are used as a single device and not as an add-on to existing levers.

In a fifth exemplary embodiment, a touch sensitive surface and associated electronics are formed as an elastic glove which is worn on top of existing brake levers. The design of the glove is such that materials with suitable friction coefficients are chosen for allowing the glove to be easily worn-in/out of the lever while allowing the glove to stay securely in place while force is exerted on it while braking or other user actions. The glove contains elastic battery cells for autonomous operation in the absence of external power. The batteries can be charged with the help of coils.

In a sixth exemplary embodiment, a touch sensitive and a light producing surface and associated electronics are formed as an elastic glove which is worn on top of existing brake levers. The design of the glove is such that materials with suitable friction coefficients are chosen for allowing the glove to be easily worn-in/out of the lever while allowing the glove to stay securely in place while force is exerted on it while braking or other user actions. The glove contains elastic battery cells for autonomous operation in the absence of external power. The batteries can be charged with the help of coils.

In a seventh exemplary embodiment, the glove is equipped with a connector to allow its batteries to be charged by connecting them via the connector to an available power source like the battery of an e-bike or motorbike, a dynamo, or a mini solar panel, or other similar device.

### BRIEF DESCRIPTION OF THE DRAWINGS

FIG. 1 shows a top-down view of typical user interaction and visual indication apparatuses, forming part of prior art, attached to the handlebar of a bicycle.

FIG. 2 shows a top-down view of novel user interaction and visual indication apparatuses, according to the present innovative solution, attached to the handlebar of a bicycle.

FIG. 3 shows a frontal, top-down view example of the operation of the novel UI and visual indication and feedback mechanism.

FIG. 4 shows a frontal, bottom-up view example of the operation of the novel UI and visual indication and feedback mechanism.

FIG. 5 shows a posterior, top-down view example of the operation of the novel UI and visual indication and feedback mechanism.

FIG. 6 shows a partially exploded posterior, top-down view of the novel UI and visual feedback hand brake lever attached to a handlebar.

FIG. 7 shows a partially exploded posterior, top-down view of an alternative implementation of the novel UI and visual feedback hand brake lever attached to a handlebar.

FIG. 8A shows a frontal, oblique view example of a novel UI and visual feedback add-on device for a hand brake lever, worn on a handlebar

FIG. 8B shows a posterior, oblique view example of a novel UI and visual feedback add-on device for a hand brake lever attached on a handlebar.

FIG. 8C shows a top-down view example of the components of FIGS. 8A-B.

FIG. 9A shows a detailed view of the outer front surface of an alternative embodiment of the gloves of FIGS. 8A-C.

FIG. 9B shows a detailed view of the outer rear surface of the glove of FIG. 9A.

FIG. 10 shows a partially exploded frontal view of a first alternative implementation of the glove of FIGS. 9A-B.

FIG. 11 shows an exploded posterior view of a second alternative implementation of the glove of FIGS. 9A-B.

FIG. 12 shows a UI and visual feedback system installed at the handlebar of a two-wheeled vehicle.

FIG. 13 shows a high-level flowchart with the states of operation of the present innovative UI and visual feedback system.

FIG. 14 shows an example flowchart diagram of UI actions triggering visual feedback in system 200.

FIG. 15 shows a flowchart diagram of an external device or application feedback triggering visual feedback in system 200.

FIG. 16 shows an example architecture of a computing device or apparatus.

FIG. 17 shows the main Software Components of a device or apparatus.

FIG. 18 shows the main Software Components of a Server.

FIG. 19 shows a hand brake lever setup in a non-engaged position and a hand brake lever setup in an engaged position.

FIG. 20 shows a hand brake lever setup with double wishbone elements in a non-engaged position and a hand brake lever setup with double wishbone elements in an engaged position.

FIG. 21 shows a user's hand operating the present innovative solution on the hand brake setup of FIG. 19.

FIG. 22 shows a user's hand operating the present innovative solution on the hand brake setup of FIG. 20.

### DETAILED DESCRIPTION

The word “exemplary” is used herein to mean “serving as an example, instance, or illustration”. Any embodiment described herein as “exemplary” is not necessarily to be construed as preferred or advantageous over other embodiments.

The acronym “API” is intended to mean “Application Programming Interface”.

The acronym “ASIC” is intended to mean “Application Specific Integrated Circuit”.

The acronym “CD” is intended to mean “Compact Disk”.

The acronym “CPU” is intended to mean “Central Processing Unit”.

The acronym “DSL” is intended to mean “Digital Subscriber Line”.

The acronym “DVD” is intended to mean “Digital Versatile Disk”.

The acronym “GPS” is intended to mean “Global Positioning System”.

The acronym “GUI” is intended to mean “Graphical User Interface”.

The acronym “LED” is intended to mean “Light Emitting Diode”.

The acronym “OLED” is intended to mean “Organic Light Emitting Diode”.

The acronym “PCB” is intended to mean “Printed Circuit Board”.

The acronym “OS” is intended to mean “Operating System”.

The acronym “UI” is intended to mean “User Interface”.

The acronym “URL” is intended to mean “Uniform Resource Locator”.

The acronym “USB” is intended to mean “Universal Serial Bus”.

The acronym “XML” is intended to mean “eXtensible Markup Language”.

The term “mobile device” may be used interchangeably with “client device” and “device with wireless capabilities”.

The term “user” may be used interchangeably with “regular user” and “ordinary user” and “rider”.

The term “2-wheeled vehicle” may be used interchangeably with “bicycle”, “e-bike”, “motorbike”, “bike”, “3-wheeled vehicle”, tricycle, and quadracycle.

For reasons of simplicity the following description and exemplary embodiments focus on bicycles and e-bikes. They are all also applicable to tricycles, quadracycles, and motorbikes even if not specifically mentioned. Unless otherwise specified, “bicycle”, “bike”, and “e-bike” or “electric bicycle” are used interchangeable and in the scope of the following description are treated equally unless otherwise specified.

The term “electronics” may be used interchangeably with “electronics module”, “electronics unit” and “electronics layer” and refer to the same entity unless otherwise specified.

The term “haptic device” may be used interchangeably with “haptic module”, “haptic unit”, “haptic feedback device”, “haptic feedback module”, “haptic feedback unit” and refer to the same entity unless otherwise specified.

The term “surface” and “face” may be used interchangeably and refer to the same entity unless otherwise specified or implied by the disclosure.

The term “light producing surface” and “light emitting surface” may be used interchangeably and refer to the same entity unless otherwise specified.

Prior Art

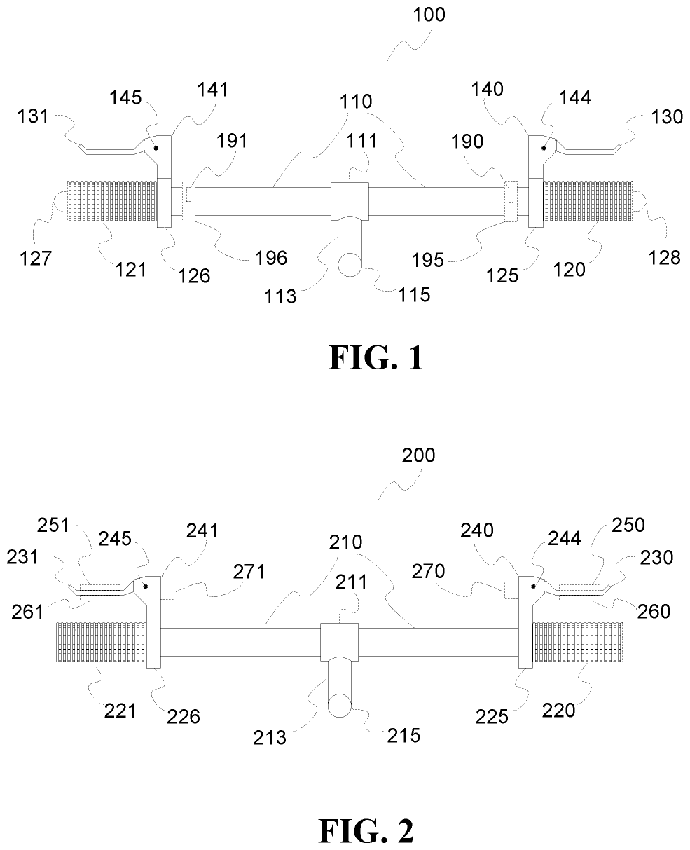

FIG. 1 shows a top-down view of typical user interaction and visual indication apparatuses, forming part of prior art, attached to the handlebar of a bicycle. A bicycle handlebar equipped with user interaction and visual indication apparatuses 100 are used in any type of bicycle and e-bike (or motorbike). Handlebar 110 is horizontally attached at its middle point to a vertical shaft 115 via connecting parts 111 and 113. Shaft 115 is connected to the bicycle frame, not shown in the figure, in a way that it turns freely around its longitudinal axis so as to allow handlebar 110 to turn around the same axis of shaft 115 and allow the rider to turn his bicycle to the left or to the right.

At both ends, bar 110 has two hand grips 120, 121, each having a shape that matches the shape of and fully encloses the cross-section of bar 110. Bar 110 may be manufactured, e.g. in metal alloy, carbon-fibers, wood, plastic or other material with sufficient strength and durability to withstand the forces exerted by a rider during riding and turning his bike. Hand grips 120, 121 are usually made of a rubber-like polymer, foam-type material, leather, synthetic leather or other material that can be easily shaped, molded, pressed, sandwiched, or otherwise manufactured to the desired shape, and which has surfaces with friction coefficients high enough to allow the hand grip to stay in place around bar 110 and prevent slipping of the rider's hands.

At the end nearer to the shaft 115 and connecting parts 111, 113 of each hand grip 120, 121, is attached a handbrake made of a pivoting hand brake lever 130, 131, handbrake body part 140, 141 and attachment part 125, 126. Lever 130, 131 pivots around a pin-type attachment 144, 145 attached on body part 140, 141. Wire ropes or hydraulic lines, and protecting and tuning parts of the hand brake are not shown in FIG. 1 for simplicity.

At the distant to the shaft 115 and connecting parts 111, 113 ends of bar 110, or of hand grips 120, 121 are optionally attached two lights that function as indicators for turning left and right.

Near the end nearer to shaft 115 and connecting parts 111, 113 of each hand grip 120, 121, is attached a switch 190, 191 that is attached to bar 110 via attachment part 195, 196, respectively. Switches 190, 191 are three-position switches, where each position corresponds to “left”, “off” and “right”. The switch has to be returned to the middle (i.e. “off” position) when the user does not intent to turn or after a turn has been completed. In alternative prior art teachings, these switches are each replaced with three individual push or touch buttons. It is noted that either switch 190, or switch 191, or both switches 190, 191 may be present in a bicycle.

For a rider to operate the switch, say switch 190, the rider has to remove his right hand from hand grip 120 and deflect switch 190 to the desired position before he can return his right hand to hand grip 120. During the operation of switch 190, the rider holds only hand grip 121 with his left hand. As a result, the rider has to maintain stable steering with only his left hand while at the same time moving his right hand to deflect switch 190. This operation can equally be done with the opposite hands to those described above.

Certain variations of prior art place switches 190, 191 in contact (or near contact) with hand grips 120, 121 so as to allow the rider to operate the switches with his thumb. This setup allows more stable steering but cannot be used by users with injured thumbs. It is also difficult to be operated by riders with short and/or weak finger, e.g. ladies and children which usually hold hand grips 120, 121 towards their distant to shaft 115 and connecting parts 111, 113 ends so as to apply maximum torque to hand brake levers 130, 131. Once switch 190, 191 is displaced to the “left” position, light 127 is switched on, and once switch 190, 191 is displaced to the “right” position, light 128 is switched on. Lights 128, 127 are switched off when switch 190, 191 is returned to the “off” position. Lights 128, 127 are flash lights manufactured either as incandescent light bulbs, Light Emitting Diodes (LEDs), LED arrays, or other similar arrangement. Usually only one switch 190 or 191 is installed on handlebar 110 and the switch to be installed is selected to match left- or right-handed riders.

In recent years, riders often use trip computers, smart phones, digital music players and other portable audio-visual devices (e.g. navigators, etc.), which they attach onto handlebar 110 for direct visual contact and interaction. In order to operate them, they typically remove one hand from handlebar 110 and place it on the device attached to handlebar 110 for pressing the control buttons of the device or for interacting via the touch screen of those devices that possess such a screen. This operation may cause accidents as the rider has to keep handlebar 110 stable with one hand while doing complex operations with his other hand and more importantly while visually and mentally focusing on the device controls or touch screen. In many situations the rider even has to listen to feedback offered by the device. This is a very dangerous situation which unfortunately causes thousands of serious accidents every year and in some cases even causes death.

With the widespread use of smart phones and other devices, user distraction is a very serious problem which necessitates an efficient solution. Currently there is no known technical solution in prior art. This need for a practical, reliant, affordable and durable solution is offered by the present innovative solution.

The Proposed Solution

FIG. 2 shows a top-down view of novel user interaction and visual indication apparatuses, according to the present innovative solution, attached to the handlebar of a bicycle.

In a first exemplary embodiment, a bicycle handlebar equipped with the user interaction and visual indication apparatuses 200 of the present invention are used in any type of bicycle and e-bike (or motorbike). Handlebar 210 is horizontally attached at its middle point to a vertical shaft 215 via connecting parts 211 and 213. Shaft 215 is connected to the bicycle frame, not shown in the figure, in a way that it turns freely around its longitudinal axis so as to allow handlebar 210 to turn around the same axis of shaft 215 and allow the rider to turn his bicycle to the left or to the right.

At both ends, bar 210 has two hand grips 220, 221, each having a shape that matches the shape of and fully encloses the cross-section of bar 210. Bar 210 may be manufactured in a metal alloy, carbon-fibers, wood, plastic or other material with sufficient strength and durability to withstand the forces exerted by a rider during riding and turning his bike. Hand grips 220, 221 are usually made of a rubber like polymer, foam-type material, leather, synthetic leather or other material that can be easily shaped, molded, pressed, sandwiched, or otherwise manufactured to the desired shape, and which has surfaces with friction coefficients high enough to allow it to stay in place around bar 210 and prevent slipping of the rider's hands.

At the end near shaft 215 and connecting parts 211, 213 of each hand grip 220, 221, is attached a handbrake made of a pivoting hand brake lever 230, 231, handbrake body part 240, 241 and attachment part 225, 226. Lever 230, 231 pivots around a pin-type attachment 244, 245 attached on body part 240, 241. Wire ropes and protecting and tuning parts of the hand brake are not shown in FIG. 2 for simplicity.

The present innovative device is the hand brake lever 230, 231 (including a brake sensor and a thumb bottom) while the remaining components are standard components widely used in the bicycle and motorbike industries. The innovative solution also contains electronics etc. that will be presented later in the specification. Lever 230, 231 may have any form known from prior art (e.g. linear, curved, designed to be operated with the index and middle fingers or with four fingers, having smooth small protrusions to provide holding “pockets” to secure the position of fingers and prevent slipping, ending in a ball-shaped feature to prevent fingers from slipping etc.). The proposed innovative hand brake lever 230, 231 may be sold as a single unit to be fitted at any bicycle or motorbike, or alternatively the lever may be attached to any available handbrake body part 240, 241 via a pin-type attachment 244, 245 attached on handbrake body part 240, 241, which pin 244, 245 allows lever 230, 231 to pivot around pin 244, 245 just like any standard lever known in prior art does.

User Interaction (UI)

The proposed innovative lever 230, 231 has a touch sensitive surface 250, 251 attached to its frontal face (or in alternative exemplary embodiments, to its upper-frontal surface, or upper surface, or between the frontal surface and the upper surface). Surfaces 250, 251 are formed to cover the part of lever 230, 231 which is designed or usually used by riders to be touched by the fingers operating the lever (2, 3 or 4 fingers). Surface 250, 251 is made of a touch sensitive material. Surface's 250, 251 thickness is exaggerated in FIG. 2 for visual clarity.

In the present exemplary embodiment touch sensitive surface 250, 251 is a piezoelectric strip, while in an alternative exemplary embodiment surface 250, 251 is made up of a capacitive surface or of several touch sensitive surfaces placed next to each other along the length of lever 230, 231. In yet another exemplary embodiment, touch surface 250, 251 is a matrix of capacitive or piezoelectric elements (coupled to a digitizer module and a processing module) or a touch screen. The operation of touch sensitive surface 250, 251 provides a simple to use User Interaction (UI) mechanism to the rider for operating portable devices, for indicating his intention to turn, and for managing e-bike assist modes, electronic gear shifting mechanisms, etc. The rider can operate the proposed innovative UI mechanism without having to alter his riding routine and in particular without having to release his hand from hand grip 220, 221. Furthermore, the proposed UI mechanism allows its user to ride his vehicle either holding hand grip 220, 221, or holding hand grip 220, 221 and at the same time having his fingers (2, 3, or 4 fingers) grip hand brake lever 230, 231. In order to correctly interpret the user's input to surface 250, 251, the proposed innovative solution needs to differentiate between touching surface 250, 251 for user input and touching for braking.

Electronics (not shown in FIG. 2) perform the necessary processing to differentiate between user input and braking. The innovative solution ignores all touch input (i.e. false/unintentional user input) on surfaces 250, 251 while braking. This design feature has a two-fold action: first it ignores finger slipping, repositioning, or change in pressure (that could otherwise be interpreted as “button press” action) during braking, and second it discourages the rider from trying to input to (i.e. interact with) surface 250, 251 which could potentially distract his attention from the riding situation and his fingers from the braking action or reduce the exerted pressure on the hand brake and result in weaker braking and even accidents.

To differentiate between braking and UI, a pressure switch 270, 271 is inserted between the lever's 230, 231 end proximal to the pivot pin 244, 245 and the handbrake body part 240, 241. In one exemplary embodiment switch 270, 271 is “on” when no braking is performed (i.e., the lever's 230, 231 end proximal to the pivot pin 244, 245 and pin 244, 245 touch). Once the user's fingers apply enough pressure to deflect lever 230, 231 from its rest (i.e. non-braking) position the switch 270, 271 switches on and the electronics detect the braking action. As a result, any finger movements and other actions (e.g., double pressing that could otherwise be interpreted as a “double click”, relative to each other movement of fingers that could be interpreted as a “zooming” operation or as a “slide” operation, etc.) are ignored until switch 270, 271 switches off and braking action ceases. The necessary pressure on lever 230, 231 to brake (and open switch 270, 271) depends on the type and tuning of the braking system upon which lever 230, 231 is installed.

In variations of the present exemplary embodiments, pressure switch 270, 271 may be connected in a reverse setup, so that it is in “on” state when no braking is performed, or it may be replaced by other types of electronic components acting as buttons and switches, like for example capacitive or resistive elements, piezoelectric elements, optical elements, optical matrices, or force sensitive resistors either on switches 270, 271 or in surfaces 250, 251, optical sensors, ultrasonic sensors, mini radars, push buttons, force sensing elements, stress sensing elements etc.

In other exemplary embodiments switch 270, 271 may optionally be placed on the upper surface of handbrake body part 240, 241 so that the user may operate the switch with his thumb, either by pressing, touching or approaching his thumb near switch 270, 271. In a variation of this exemplary setup, switch 270, 271 is placed on attachment part 225, 226 for better ergonomic access by the rider's thumb.

It is noted that innovative hand brake lever 230, 231 and/or switch 270, 271 may be installed at either the left or right side of handlebar 210 to accommodate left or right handed riders, or at both sides for accommodating both types of riders or for accepting commands from both sides (e.g. the left side input may be assigned to correspond to an “up-down” action or to a 1^{st} application control while the ride side input may be assigned to correspond to a “left-right” action or to a 2^{nd} application control, etc.).

The innovative UI-enabled hand brake lever 230, 231 in FIG. 2 allows the user to interact without distracting his balance, his normal handlebar handling and without releasing any hand from the handlebar.

In alternative exemplary embodiment, switch 270, 271 is replaced by a sensor for detecting pressing action of the handbrake lever. This pressing action may be effected by a force applied on the handbrake lever in any direction and the detection of this pressing action may be used to differentiate between intentional touch input and unintentional touch input. The sensor (or the switch in the previous embodiment) is connected with the electronics modules and may also be directly connected with a power module if the electronics module does not supply the power needed for its operation. In one aspect a sensor is used for each direction of applied force.

In another exemplary embodiment hand brake lever 230, 231 has an optional miniature electric cam motor (not shown in FIG. 2), i.e. a motor that is slightly off-balanced to produce vibrations, or a linear mass actuator, i.e. a vibration motor that produces an oscillating force across a single axis by relying on an AC voltage to drive a voice coil pressed against a moving mass connected to a spring. The cam motor (or the linear mass actuator) is attached to lever 230, 231 and when operating (i.e. “on” state) the motor transmits vibrations to lever 230, 231 which are felt by the rider's fingers touching (and interacting with) touch sensitive surface 250, 251 on the front face of lever 230, 231. The cam motor is connected with the electronics module, which controls it and may also be connected with a power module if the electronics do not supply the necessary power for its operation. The intensity and frequency of the vibrations may be adjusted by adjusting the turning speed of the motor. By means of example, low intensity and frequency vibrations may be triggered automatically by the electronics when the user's fingers are touching surface 250, 251 (as sensed by the surface itself) and high intensity and frequency vibrations may be triggered when the user is not touching hand brake lever 230, 231 so as the vibrations may be felt by the rider's hand on hand grip 220, 221.

A modification to this exemplary embodiment may place the cam motor (or the linear mass actuator) on hand grip 220, 221, or in handlebar 210, or on handbrake body 240, 241, or use two cam motors, the first motor on lever 230, 231 and the second motor on hand grip 220, 221. According to the particular exemplary embodiment used, cam motor or motors may be use on the left, the right, or both sides of handlebar 210. In a variation of the present exemplary embodiment, the rider may select to switch “on” and “off” the haptic operation (i.e. the cam motor) and adjust intensity and patterns of operation to his liking (e.g. set different vibration patters to indicate different events, like confirmations of various UIs and various indication like directions from a navigator device or application, or an incoming call at a connected smart phone).

The resulting lever 230, 231 and/or hand grip 220, 221 act as haptic devices providing sense (i.e. vibration feedback) to the rider to confirm his input or to alert his attention.

The present exemplary embodiment may function as a user interface device for not distracting the rider during his ride.

Visual Indications and Feedback

A second exemplary embodiment builds on top of the components of the first exemplary embodiment. The proposed innovative lever 230, 231 has a light producing surface 260, 261 attached to its back face (or to the upper surface, or between the back surface and the upper surface). Surface 260, 261 is formed to cover the posterior part of lever 230, 231 which is not touched or covered by the rider's fingers operating the lever (2, 3 or 4 fingers), and as a result surface 260, 261 is unobstructed and visible both by the rider and by others (e.g., riders, drivers and pedestrians) behind the rider. Surface 260, 261 is made of a strip of light producing elements, like a Light Emitting Diode (LED) strip. Surface's 260, 261 thickness is exaggerated in FIG. 2 for visual clarity.

In an alternative exemplary embodiment surface 260, 261 is made up of several miniature incandescent light bulbs placed next to each other along the length of lever 230, 231. In yet another exemplary embodiment, surface 260, 261 is a matrix of LEDs or miniature incandescent light bulbs, or a curved screen (e.g. if the lever has a curved plane), or a flat screen (e.g. one suitable for viewing under sunlight and during low or no ambient light. These components may be integrated of connected to an external electronic unit, like a digitizer, a processing unit, or a Central Processing Unit (CPU) for conditioning their electrical signal and interfacing with other components. The CPU contains at least one memory unit, either internal, external, or a combination of the two.

Light producing surface 260, 261 has a two-fold use: (a) to provide the rider with feedback (e.g. displaying feedback from the portable devices, e-bike system, electronic gear shifter etc., and applications he operates via touch sensitive [i.e. UI] surface 250, 251, and visual confirmation of correct reception and interpretation of his input to surface 250, 251), and (b) to provide others with visual indications (i.e. riders intention to turn left, or braking action, etc.). The information displayed on the light producing surface 260, 261 is controlled and presented by the (one or more) electronics unit.

Light producing surface 260, 261 may produce single-color visual signals or may support various colors. In the latter case, red indications may, for example, correspond to braking, green or white to feedback to the user and yellow to indicate the rider's intention to turn (either in a flashing mode or a moving line, etc.). Similarly, colors and light patterns may be assigned to information related to specific actions and indications produced by mobile devices connected to the interaction and visual feedback surfaces. In another example, colors are used to visualize signals from a navigation application running at the rider's smartphone, so that a yellow color on one side may indicate instructions for turning towards this direction, a yellow color on both sides may indicate arrival at destination, a red color on both sides may prompt the rider to make a U-turn.

In a variation of the present exemplary embodiment, the user may select colors and light patterns, as well as, assign them to specific feedback and/or indication actions.

The rider can use the proposed innovative visual indication and feedback mechanism without having to alter his riding routine, without having to release his hand(s) from hand grips 220, 221, and more importantly with minimal or no distraction from his riding routing and sight. Even if the rider selects to consult the visual indications on light producing surfaces 260, 261, he has to slight lower his eyes and direction of sight (i.e. no need to move his head), and he has to read an over simplified visual display as opposed to the complex, highly detailed and difficult to read (both in daylight due to low contrast and during low or no ambient light conditions where a detailed screen might significantly negatively affect the sensitivity of his eyes to the low light conditions he faces during riding). The oversimplified visual feedback from light producing surfaces 260, 261 needs minimal effort and time to read and can be interpreted even with peripheral vision in most cases by using simple light signals like the ones previously described by means of example and without limiting the scope of the present innovative solution.

In alternative exemplary embodiments, visual feedback can be reduced even further by replacing a subset of or all the visual feedback signals with haptic feedback (vibrations) produced by a haptic feedback device like a cam motor(s) and delivered to the rider's fingers or combined and/or replaced with synchronized audio signals. In a further modification to these exemplary embodiments, audio signals are produced only after sensing (with a mini microphone, e.g. the microphone of a connected smartphone, or a microphone installed on the vehicle, or carried or worn by the rider) that the ambient sound is below a preset level (either automatically or user selected), where this sound level is deemed to allow easy auditory reception by the rider. The rider may also manually adjust the volume of such auditory signals.

In an alternative exemplary embodiment electronics in the handbrake lever communicate with wireless (or wired) earphones worn by the rider, or with mini speakers attached to or integrated in the rider's helmet.

The innovative combined visual indication and feedback lever 230, 231 in FIG. 2 allows the user to receive feedback (e.g. confirmation of his UI), information, and to be alerted with minimal or no distraction due to the position of the visual feedback, the oversimplification of the provided information, its adaptation to various parameters of use, and its combination with haptic feedback. Furthermore, the use of light producing surfaces 260, 261 eliminates the need for flashing indicator lights 128, 127 (refer to FIG. 1).

In an alternative exemplary embodiment, the touch sensitive surface and the light emitting surface are both placed in the upper face of the handbrake lever for easier operation and visibility by the rider. In such a setup there is no support for visual information to others behind the rider (e.g. other riders, driver, or pedestrians). The touch sensitive surface is dimensioned to approximately half the length of the handbrake lever and the light emitting surface is also dimensioned to approximately half the length of the handbrake lever, and the two surfaces are placed next to (and near) each other along the length of the lever. In a variation of this exemplary implementation, the length and/or width of the two surfaces relative to each other may differ. In yet another variation of this exemplary implementation, the two surfaces are placed in parallel near each other, instead of next to each other along the length of the lever.

In an alternative exemplary embodiment, the visual feedback apparatus is constructed and used independently and without the user interaction apparatus. This embodiment has a light producing surface, an electronics layer, and a support layer. It lacks the touch sensitive surface.

In all the previous exemplary embodiments the electronics layer (or unit) may be replaced by more electronics layers (or units) without departing from the scope of the invention.

User Operation of the UI and Visual Feedback Mechanism

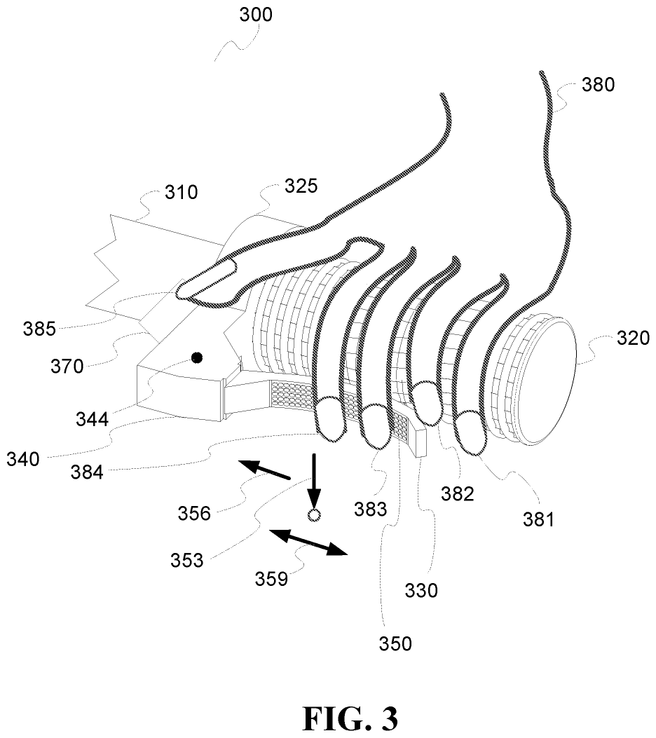

FIG. 3 shows a frontal, top-down view example of the operation of the novel UI and visual indication and feedback mechanism. A rider's hand operating the proposed innovative solution is shown 300. The rider places his hand 380 on handlebar 310 and in particular on hand grip 320. The exemplary embodiment illustrated in FIG. 3 shows an embodiment where a hand brake lever 330 is designed to be operated with the index 384 and middle 383 fingers, while the two smaller fingers 382, 381 grab hand grip 320. In variations of the present exemplary embodiment, lever 330 may be designed for operation by four fingers 381-384. Lever 330 is pivoting around pin 344 secured on handbrake body part 340, which is in turn attached to handlebar 310 via attachment part 325.

An optional button 370 is positioned on handbrake body part 340 (or on attachment part 325 in a variation of the present exemplary setup), which button is operated by the rider's thumb 385 to indicate that he is not braking and the present innovative solution can accept his UI as sensed by touch sensitive surface 350 detecting the rider's finger 383, 384 touch/pressure and movements. An optional software (used in both the first and second exemplary embodiments) may be used to determine whether a rider's command is intentional and should be accounted by the system, or accidental when the rider just touches the lever (e.g. for other type of interaction with the system, like to indicate turning) and should be ignored. Such an algorithm may, for example, use time and/or pressure thresholds to differentiate between the two cases. By means of example, a very short-duration interaction or a very light pressure on the lever are not to be interpreted as a braking action. In one implementation, the algorithm is configured to reject user touches and finger movements on the touch sensitive surface that deviate from a strict, pre-defined set of touches and movement patterns that a rider is allowed to use as commands. These patterns must be chosen carefully so that they are not done inadvertently during other instances such as braking or resting the rider's fingers on the lever while riding. In other exemplary embodiments, button 370 is inserted between lever's 330 end proximal to the pivot pin 344 and the handbrake body part 340, thereby allowing automatic operation without the rider having to press it. Implementation examples of button 370 where presented in the description of FIG. 2.

Index 384 and middle 383 fingers grab and rest on the front face of lever 330. On the front face of lever 330, a touch sensitive surface 350 is attached, so that the rider's fingers 384, 383 are in contact with surface 350. When braking, any pressure or movement of fingers on surface 350 is ignored. When not braking, the user presses button 370 with his thumb 385, either once or for the duration of the UI that is effected by his index 384 and middle 383 fingers on touch sensitive surface 350. In a variation of this setup, special software, as previously described, may be optionally used to reject random or accidental touches on the lever, thereby alleviating the need for a thumb button 370. In alternative exemplary embodiments where there is no thumb operated button 370, button 370 is placed in the touch area between lever 330 and handbrake body part 340 (when the brake is not engaged) and is, therefore automatically operated every time the rider engages braking. This embodiment is not shown in FIG. 3.

The rider can operate the UI functionality and interact with lights and portable devices and applications by pressing or moving his index 384 and/or middle 383 fingers (or any or the combination of his four fingers 381-384 in alternative embodiments).

By means of example, the rider may press 353 or swipe down his index finger 384 (e.g. to indicate a choice associated with a mobile device or application, like pausing the reproduction of music playback on a mobile phone or a portable music player), or move 356 his index finger 384 towards his thumb, or swipe right (e.g. to indicate his intention to turn right—the use of this left hand to indicate a right turn may be especially useful to a left hand rider), or move both his index 384 and/or middle 383 fingers in opposite directions 359, or pinch-in e.g. to indicate zooming-in a map presented on the screen of a portable navigation device or smartphone attached to handlebar 310, or to stop the music reproduction or the audio guidance associated with a portable device or a smartphone (running a navigation application) both stored out of the rider's sight in his backpack or in a storage pocket attached to the frame or handlebar of his bicycle (or e-bike or motorbike).

User's UI, derived from finger pressure and/or movements is interpreted by electronics and visual feedback is produced on a light producing surface (not shown) for the rider to see, understand and interpret. Such visual feedback is made of oversimplified indications that are easy to see, understand and interpret and which do not require effort nor disturb the rider. Visual feedback may also target others except the rider or both. By means of example, visual feedback may be an orange flashing or moving arrow or line to indicate to others the rider's intention to turn and optionally to the rider to confirm his UI, a flashing or still green arrow or line, or a moving arrow or line to indicate to the rider instructions from a navigation application (e.g., running in a portable navigation device or smart phone stored or carried out of the rider's sight for minimizing distraction) or a visual representation of command buttons (e.g. “play” and “stop” for a music playback application) which are associated with approximate areas on the touch sensitive surface 350 on the opposite face of lever 330, for the rider to provide his input/commands, etc.), or visual arrows to indicate a slide direction to perform actions (e.g. “play” and “stop” for the music playback application).

Details on the potential candidates for implementing the various components of FIG. 3 are given in FIG. 2. FIG. 3 shows a left hand operating the proposed innovative solution. The right hand or both hands can equally be used. The rider may associate finger actions with actions on devices, applications, and the light producing surface.

In another exemplary embodiment, button 370 is removed and at the back surface of touch sensitive surface 350 a strip of (or one or more) touch-sensitive resistors are added (not shown). When the rider wants to brake, he exerts significantly more pressure compared to non-braking. This pressure is detected by the hardware connected to the pressure sensitive resistor(s) and, thus, the braking action is detected. A change above a predefined threshold of the resistivity of the pressure sensitive resistance(s) can be associated with a braking action.

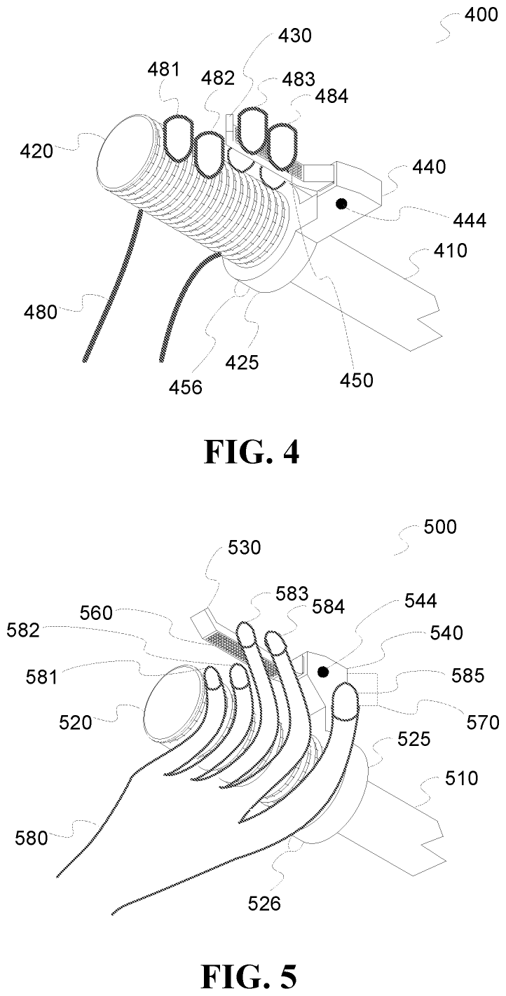

FIG. 4 shows a frontal, bottom-up view example of the operation of the novel UI and visual indication and feedback mechanism. A rider's hand operating the proposed innovative solution is shown 400. The rider places his hand 480 on handlebar 410 and in particular on hand grip 420. The exemplary embodiment illustrated in FIG. 4 shows an embodiment where a hand brake lever 430 is designed to be operated with the index 484 and middle 483 fingers, while the two smaller fingers 482, 481 grab hand grip 420. In variations of the present exemplary embodiment, lever 430 may be designed for operation by four fingers 481-484. Lever 430 is pivoting around pin 444 secured on handbrake body part 440, which is in turn attached to handlebar 410 via attachment part 425 and an optional screw 456.

An optional button is positioned on handbrake body part 440 (not visible in this view), which button is operated by the rider's thumb (not shown) to indicate that he is not braking and the present innovative solution can accept his UI as sensed by touch sensitive surface 450 detecting the rider's finger 483, 484 touch/pressure and movements. In other exemplary embodiments the button is inserted between lever's 430 end proximal to the pivot pin 444 and the handbrake body part 440, thereby allowing automatic operation without the rider having to press it. Alternatively, a button at or near position 456 may be used instead. Special software like the one previously mentioned may be used to filter out random or accidental touches.

Index 484 and middle 483 fingers grab and rest on the front face of lever 430. On the front face, a touch sensitive surface 450 is attached, so that the rider's fingers 484, 483 are in contact with surface 450. When braking, any pressure or movement of fingers on surface 450 is ignored. In one implementation, when not braking, the user presses the button with his thumb, either once or for the duration of the UI that is effected by his index 484 and middle 483 fingers on touch sensitive surface 450. In a different implementation the user does not need to press the button with his thumb, as software rejects all interactions while braking action is detected. Both implementations can also be used for e-bikes to cut-off power when braking both for preserving power and entering braking-charge mode, and as a safety feature to make braking more effective In alternative exemplary embodiments where there is no thumb operated button, the button is placed in the touch area between lever 430 and handbrake body part 440 (when the brake is not engaged) and is, therefore automatically operated every time the rider engages braking.

The rider can operate the UI functionality and interact with lights and portable devices and applications by pressing or moving his index 484 and/or middle 483 fingers (or any or the combination of his four fingers 481-484 in alternative embodiments).

User's UI, derived from finger pressure and/or movements is interpreted by electronics and visual feedback is produced on a light producing surface (not visible in FIG. 4) for the rider and/or others to read.

FIG. 5 shows a posterior, top-down view example of the operation of the novel UI and visual indication and feedback mechanism. A rider's hand operating the proposed innovative solution is shown 500. The rider places his hand 580 on handlebar 510 and in particular on hand grip 520. The exemplary embodiment illustrated in FIG. 5 shows an embodiment where a hand brake lever 530 is designed to be operated with the index 584 and middle 583 fingers, while the two smaller fingers 582, 581 grab hand grip 520. In variations of the present exemplary embodiment, lever 530 may be designed for operation by four fingers 581-584. Lever 530 is pivoting around pin 544 secured on handbrake body part 540, which is in turn attached to handlebar 510 via attachment part 525 and optional screw 526.

An optional button 570 is positioned on handbrake body part 540, which button is operated by the rider's thumb 585 to indicate that he is not braking and the present innovative solution can accept his UI as sensed by touch sensitive surface (not visible in FIG. 5—opposite display surface 560) detecting the rider's finger 583, 584 touch/pressure and movements. In other exemplary embodiments button 570 is inserted between lever's 530 end proximal to the pivot pin 544 and the handbrake body part 540, thereby allowing automatic operation without the rider having to press it. In another exemplary embodiment, button 570 is replaced by software that detects and filters out random and accidental touches.

Index 584 and middle 583 fingers grab and rest on the front face of lever 530. On the front face, a touch sensitive surface (not visible) is attached, so that the riders fingers 584, 583 are in contact with the touch sensitive surface (not visible in FIG. 5—opposite display surface 560). When braking, any pressure or movement of fingers on the touch sensitive surface is ignored. When not braking, the user presses button 570 with his thumb 585, either once or for the duration of the UI that is effected by his index 584 and middle 583 fingers on touch sensitive surface 550. In another exemplary embodiment, button 570 is replaced by software that detects and filters out random and accidental touches. In alternative exemplary embodiments where there is no thumb operated button 570, button 570 is placed in the touch area between lever 530 and handbrake body part 540 (when the brake is not engaged) and is, therefore automatically operated every time the rider engages braking.

The rider can operate the UI functionality and interact with lights and portable devices, bike/e-bike system and mechanisms, and applications by pressing or moving his index 584 and/or middle 583 fingers (or any or the combination of his four fingers 581-584 in alternative embodiments).

User's UI, derived from finger pressure and/or movements is interpreted by electronics and visual feedback is produced on a light producing surface 560 for the rider to read. Such visual feedback is made of oversimplified indications that are easy to read and which do not require effort to read them nor disturb the rider. Visual feedback may also target others except the rider or both.

Assembling the Innovative UI and Visual Feedback Hand Brake Lever

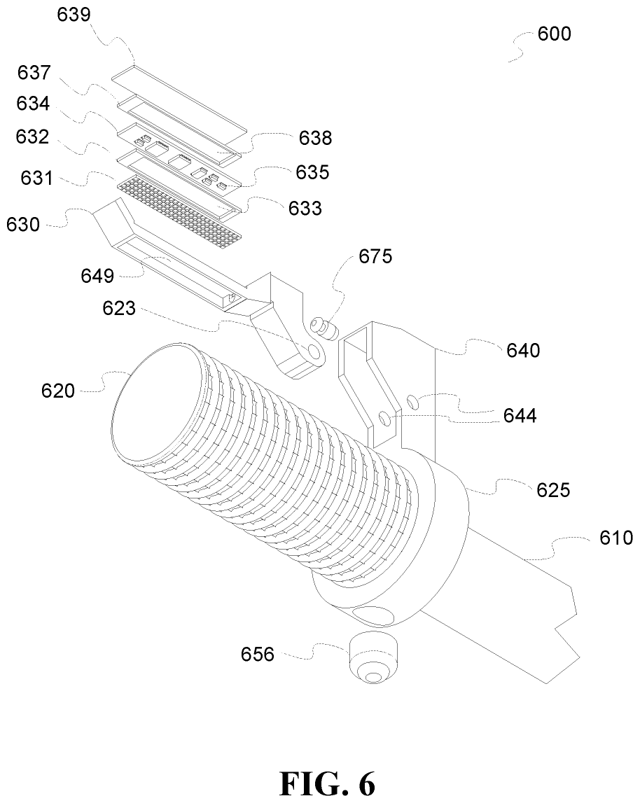

FIG. 6 shows a partially exploded posterior, top-down view of the novel UI and visual feedback hand brake lever attached to a handlebar. A third and fourth exemplary embodiments are presented. The third exemplary embodiment is used only for user interaction (and does not contain a visual feedback surface and associated electronics). The fourth exemplary embodiment is used for user interaction and visual feedback. Partially exploded view of the lever attached to the handlebar 600 will help describe how the present innovative solution is manufactured and assembled using off-the-shelf and/or custom-made components. Hand brake lever 630 is pivoting around pin 644 attached to a handbrake body part 640, which is in turn attached to a handlebar 610 via an attachment part 625 secured on handlebar 610 via optional screw (not shown) upon which an optional button 656 is attached for indicating user input. A hand grip 620 is also attached to the end of handlebar 610.

Lever 630 is designed with a gap 649 running along its length, and a fixture part with a hole 623 for attachment via pin 644 to the handbrake body part 640. In between lever 630 and handbrake body part 640 is positioned a switch 675 to detect braking action for regulating the use of user input (user input is ignored during braking) as described in the previous figures.

Inside gap 649 of lever 630 are sandwiched 5 component layers that create a two-faceted component with a touch sensitive (i.e. UI) frontal face and a visual indicator posterior face. In one exemplary implementation all five layers have dimension to securely fit inside gap 649, while in other exemplary implementations one of the two end layers or both end layers have slightly larger dimensions to serve as fixture points about gap 649 for all 5 layers. Other variations in dimensions may be chosen as long as the sandwiched five-layer (or fewer layers, e.g. three-layer) two-faced component can fit gap 649 and be secured on lever 630.

The sandwiched component is secured on lever 630 such that a first layer 631, composed of a light producing surface (as previously described) faces the back of the vehicle and can be easily read by the rider and others behind him. A second layer 632 (with an empty space 633) made of an insulating, foam, rubber, Printed Circuit Board (PCB) or other material is placed on top of light producing layer 631 and acts as a support (i.e. spacer) for a third layer 634. The third layer 634 is a PCB layer upon which electronic components needed to drive the light elements of light producing layer 631 and read the touch sensitive elements of a fifth layer 639 (used for UI) are securely attached. A fourth layer 637 is sandwiched between the third 634 and fifth 639 layers. Fourth layer 637 (with an empty space 638) is made of an insulating, foam, rubber, PCB or other material and acts as a support for fifth layer 639. Second 632 and fourth 637 support layers have a second function; to house and protect electronic components 635 that protrude on either or both sides of third layer 634. Connecting cables and other secondary components and connections are not shown in FIG. 6 for visual clarity.

In this particular implementation third layer 634 electronics 635 perform interfacing, low level control functions (e.g. Analogue to Digital [A/D] conversion), and communication with an external processing unit (not shown) that may be attached on handlebar 610, or housed or stored at a position on the vehicle's frame, storage pocket, rider's backpack, etc., or with an e-bike's or motorbikes computer and electronics.

In an alternative exemplary implementation third layer 634 houses electronics 635 with enough processing power to act as an autonomous processing unit to fully support the operation of the present innovative solution. Power supply is not shown in FIG. 6 for visual clarity. In the third exemplary embodiment, the light emitting layer 639 is omitted and spacing layer 637 may be optionally used, In a variation of the third exemplary embodiment, lever 630 contains a depression formed and size to accommodate layers 631, 632, 634 and (optionally) 637, while its rear surface may be non-void so as to provide support and protection for layer 631, 632, 634 and (optionally) 637.

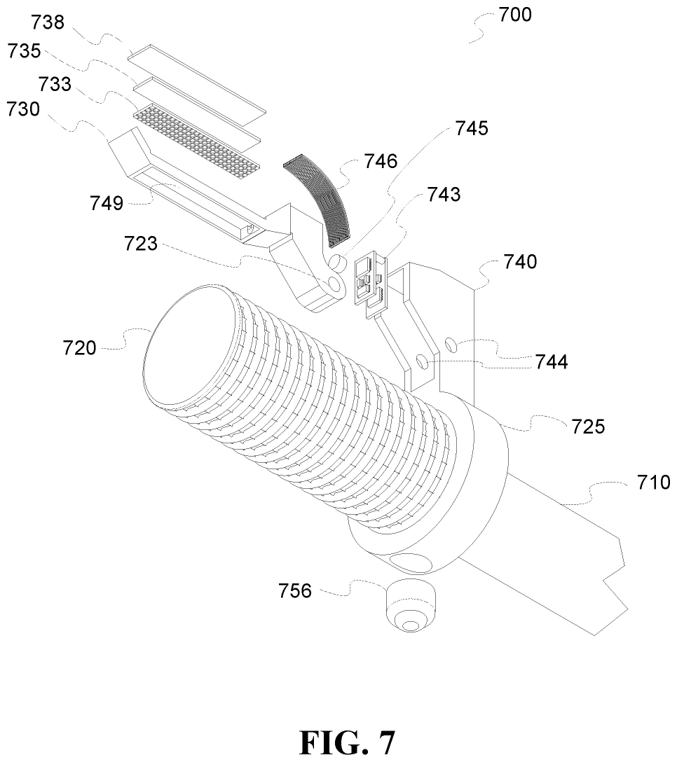

FIG. 7 shows a partially exploded posterior, top-down view of an alternative implementation of the novel UI and visual feedback hand brake lever attached to a handlebar. Partially exploded view of the lever attached to the handlebar 700 will help describe how the present innovative solution is manufactured and assembled using off-the-shelf and/or custom-made components. Hand brake lever 730 is pivoting around pin 744, which is attached to a handbrake body part 740, which is in turn attached to a handlebar 710 via an attachment part 725 secured on handlebar 710 via optional screw (not shown) upon which an optional button 756 is attached for indicating user input. A hand grip 720 is also attached to the end of handlebar 710.

Lever 730 is designed with a gap 749 running along its length, and a fixture part with a hole 723 for attachment via pin 744 to the handbrake body part 740. In between lever 730 and handbrake body part 740 is positioned a magnet 745 (attached on hand lever 730), which operates with magnetic sensor 743 (attached on handbrake body part 740) acting as a switch to detect braking action for regulating the use of user input (user input is ignored during braking). Magnetic sensor 743 houses all the necessary electronics to operate the switch.

In alternative exemplary embodiments, magnetic sensor 743 is integrated with interfacing and communication hardware to communicate (wired or wirelessly) with an external processing unit. In a variation of this alternative exemplary embodiments, the integrated sensor 743 and additional hardware are designed to be used as a fully functional processing unit.

In other exemplary embodiments magnetic sensor 743 is replaced by an ultrasonic or light (e.g. LED transceiver) sensor or mini radar. Magnet 745 is scrapped in these embodiments.

Inside gap 749 of lever 730 are sandwiched 3 component layers (or 5 in other exemplary embodiments—not shown) that create a two-faceted component with a touch sensitive (i.e. UI) frontal face and a visual indicator posterior face. In one exemplary implementation all 3 layers have dimension to securely fit inside gap 749, while in other exemplary implementations the two end layers (or just one layer) have slightly larger dimensions to serve as fixture points about gap 749 for all 3 layers. Other variations in dimensions may be chosen as long as the sandwiched three-layer two-faced component can fit gap 749 and be secured on lever 730.

The sandwiched component is secured on lever 730 such that a first layer 733, composed of a light producing surface (as previously described) faces the back of the two wheeled vehicle and can be easily read by the rider and others behind him. A second layer 735 made of an insulating, foam, rubber, PCB or other material is placed on top of light producing layer 733 and acts as a support for first layer 733 and a third layer 738. Third layer 738 is made of touch sensitive elements (used for UI). First 733 and third 738 layers have a minimum of interface hardware components to connect via a thin flat cable tape 746 to a processing unit. In one exemplary embodiment the processing unit is integrated with magnetic sensor 743, while in an alternative exemplary embodiment, the processing unit is attached either to handbrake body part 740, or to handlebar 710.

In an alternative exemplary embodiment, cable tape 746 and processing unit 743 may be used in the setup described in FIG. 6.

Other connecting cables and other secondary components and connections are not shown in FIG. 7 for visual simplicity.

In FIGS. 2-7 there may be included power modules, not shown in the figures, in the form of batteries or power connectors or coils without batteries, which provide the power necessary for the operation of the electronic components of the exemplary embodiments. These batteries may be charged either wirelessly via coils, or via connectors (e.g. USB-C or other proprietary or standard connector) drawing power for external batteries, the battery of an e-bike or motorbike, mini solar panels, power banks, dynamos, etc.

Innovative UI and Visual Feedback Hand Brake Lever Glove Add-On

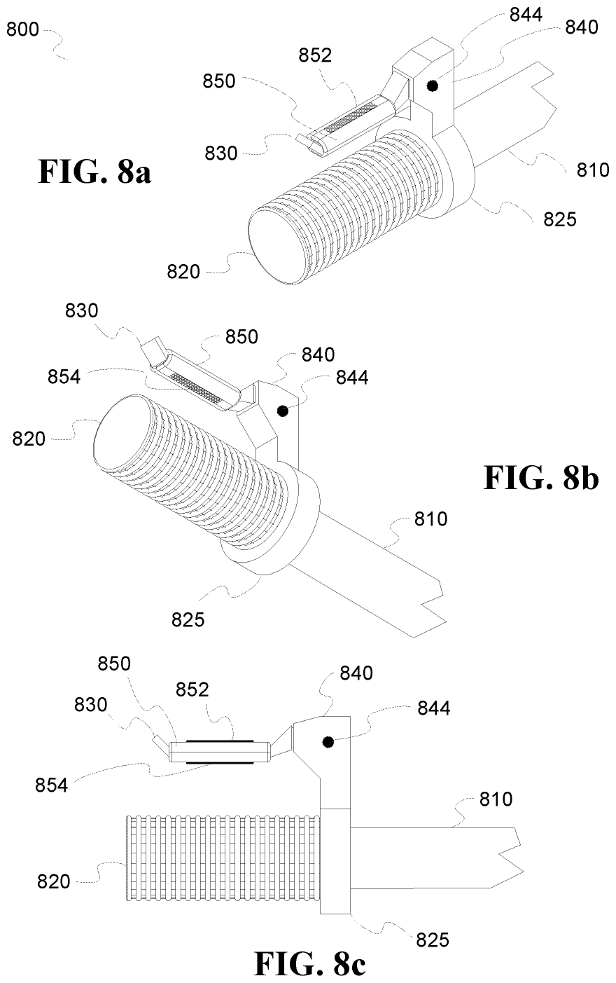

Various views 800 of a novel UI and visual feedback glove-type add-on device for a hand brake lever attached to a handlebar are presented below. FIG. 8A shows a frontal, oblique view example of a novel UI and visual feedback add-on device for a hand brake lever, attached on a handlebar. In a fifth exemplary embodiment, a hand brake lever 830 is attached to a handbrake body part 840 via pin 844, which body part 840 is attached to a handlebar 810 via an attachment part 825. A hand grip 820 is also attached to the end of handlebar 810.

Lever 830 can be any type of hand brake lever installed in any type of bicycle, e-bike, scooter, e-scooter, tricycle, quadracycle, etc., or motorbike. The innovative exemplary embodiment of FIG. 8A allows to add UI and visual feedback functionalities to be commercially available on two-wheeled vehicles, three-wheeled vehicles, or quadracycles without having to replace their existing hand brake levers with one of the levers described in FIGS. 2-7. To achieve this result, the touch sensitive and the light producing surfaces together with electronic and other secondary components are formed in a glove-like device 850 that can be worn on any type of hand brake lever 830. Seen from the front, the glove completely encloses at least the part of the lever designed to receive the rider's fingers (2, 3, or 4 fingers). Along the length of the glove's 850 frontal surface, a touch sensitive surface 852 (e.g. a strip) is attached. Touch sensitive surface is preferably formed of a semi-flexible or flexible material so as to withstand deformations during the application of glove 850 to lever 830. To support such a flexible touch sensitive surface 852, glove 850 is made of an elastic material like (by means of example and without limiting the scope of manufacture, use, operation and protection of the current exemplary embodiment) rubber, foam, elastic polymer, woven elastic fabric, non-woven elastic fabric and the like. In an alternative exemplary embodiment, on the back surface of the glove (in contact with the handbrake lever) with respect to the touch sensitive surface, a rubber strip of higher friction coefficient compared to the rest of the glove is added. This high-friction rubber component, every time the rider exerts pressure on the touch sensitive surface, is pressed against the handbrake lever and as a result friction between the rubber strip and the lever increases and the glove stays securely in place.

FIG. 8B shows a posterior, oblique view example of a novel UI and visual feedback add-on device for a hand brake lever attached on a handlebar. In a sixth exemplary embodiment, a hand brake lever 830 is attached to handbrake body part 840 via pin 844, which body part 840 is attached to handlebar 810 via an attachment part 825. A hand grip 820 is also attached to the end of handlebar 810.

The touch sensitive and the light producing surfaces together with electronic and other secondary components, which are formed in glove-like device 850 are worn on any type of hand brake lever 830. Seen from behind, the glove completely encloses the part of the lever designed to receive the rider's fingers (2, 3, or 4 fingers). Along the length of the glove's 850 posterior surface, a light producing surface 854 (e.g. a LED strip, strip of miniature incandescent bulbs, flexible display, flexible Organic Light Emitting Diode (OLED) display, etc.) is attached. Light producing surface 854 is preferably formed of a semi-flexible or flexible material to as to withstand deformations during the application of glove 850 to lever 830. A touch sensitive surface is formed at the frontal surface of glove-like device 850 but is not visible in the current view.

FIG. 8C shows a top-down view example of the components of FIGS. 8A-B. Hand brake lever 830 is attached to handbrake body part 840 via pin 844, which body part 840 is attached to handlebar 810 via an attachment part 825. A hand grip 820 is also attached to the end of handlebar 810.

The touch sensitive 852 and the light producing 854 surfaces are shown while electronics and other secondary components are not visible. These surfaces which are formed in glove-like device 850 are worn on any type of hand brake lever 830 and glove 850 completely encloses the part of the lever designed to receive the rider's fingers (2, 3, or 4 fingers).

The interior and the exterior surfaces of glove 850 have friction coefficients that are high enough to securely keep the glove on the desired position on lever 830, and prevent the rider's hands from slipping from touch sensitive surface 852. The range of friction coefficient and the exact chemical composition of the chosen materials is beyond the scope of protection of the present innovative solution and is known to persons of ordinary skill in related art. Numerous alternative materials can be used, all known to bicycle and motorcycle component manufacturers and to riders using such components.

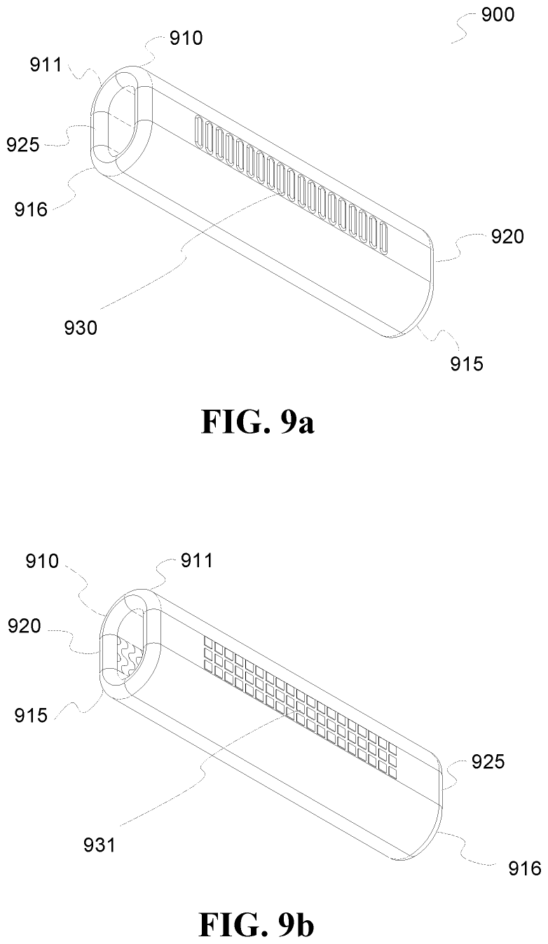

FIG. 9A shows a detailed view of the outer front surface of an alternative embodiment of the gloves of FIGS. 8A-C. In FIGS. 8A-C the glove is made of a uniform elastic material. In the exemplary embodiment of FIG. 9A, elastic glove 900 is made of an elastic material with a cylindrical shape, when not deformed, which is formed as a 6-faced longitudinal elastic part 910, 911, 925, 916, 915, 920 of a material with either the same or different elasticity or flexibility. These six longitudinal parts are connected to each other by any means know in prior art, such but not limited to stitching, molding, glueing, thermo-connected, or other. The choice of elasticity and flexibility of the components of glove 900 is done to accommodate extra components attached to them (touch sensitive surface) and to provide a controlled-flexibility base for glove 900 to stay in place on the brake lever when in use, subject to torque producing forces exerted to the glove by the rider's fingers during UI and especially during braking. Choosing materials that have a similar flexibility to the extra components attached to them (e.g. touch sensitive surface 930) can also help protect these components from damage. In a variation of the present exemplary embodiment elastic glove 900 may be implemented with more or with less than 6 faces.

FIG. 9B shows a detailed view of the outer rear surface of the glove of FIG. 9A. Elastic glove 900 is made of an elastic material with a cylindrical shape when not deformed, formed as a 6-faced longitudinal elastic part 910, 911, 925, 916, 915, 920. The rear surface 925 of glove 900 has a light producing surface 931 along its length. Choosing materials that have a similar flexibility to the light producing surface 931 can help protect surface 931 from damage during UI and braking actions, as well as during applying and removing the glove from the lever.

Surfaces 930, 931 may be formed to run either the entire length of glove's 900 longitudinal elastic parts 920, 925 upon which they are attached, or run only along a useful sub-length according to the particular exemplary implementation. In a variation of the present exemplary embodiment elastic glove 900 may be implemented with more or with less than 6 faces.

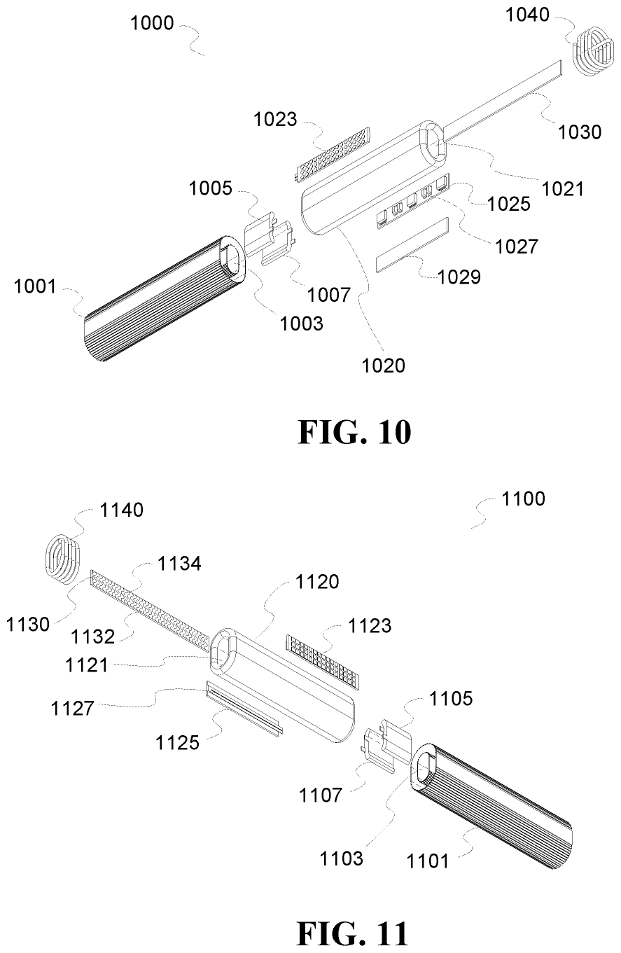

FIG. 10 shows a partially exploded frontal view of a first alternative implementation of the glove of FIGS. 9A-B. Glove 1000 is made up of a 6-faced elastic and flexible glove component 1020, having a hole 1021 along its entire length. Upon component 1020 a touch sensitive surface 1023 is attached at its frontal face and a light producing surface 1029 is attached to its posterior face. A mid layer 1025 housing electronic component 1027 in its frontal, posterior, or both faces is inserted either adjacent to surface 1023 or 1029. In alternative exemplary embodiments, two mid layers (not shown) are inserted, each mid layer below one of surfaces 1023 or 1029. Mid layer(s) 1025 are wired with external layers 1023, 1029. The wiring is not shown for visual simplicity.

Components 1023, 1029, 1025 are securely attached to each other at their two distant ends; at one end by a pair of flexible battery cell members 1005, 1007 facing each other; at the other end by a metal coil 1040, which also serves the charging function of glove 1000. The position of members 1005, 1007 and coil 1040 may be swapped. When not in use, glove 1000 is removed from the hand brake lever and is placed around a coil member or an external charging device, whether a battery-operated charging device or one connected to mains power either directly or via a voltage transformer. In a modification of the exemplary embodiment, the pair of flexible battery cell members 1005, 1007 are replaced by any type of energy storage module, typically a battery, a rechargeable battery, etc.

In a seventh exemplary implementation, charging is done via a standard connector (e.g. Universal Serial Bus (USB), or USB type C (USB-C) connector) acting as a charging module, which replaces coil 1040. Other types of standard or proprietary plugs may be used for charging. The connector may be connected to the battery of an e-bike or motorbike, an external battery, power bank, mini solar panel, charger, mains (with or without a transformer), dynamo, or other power source. The charging module can work with any type of energy storage module.

The above components of glove 1000 are also enclosed in an elastic cylindrical component 1001 with a hole 1003 along its length made of a material with a friction coefficient high enough to prevent the glove from moving, twisting, or turning on the handbrake lever during UI or braking actions, and the rider's hand from slipping during UI and especially during braking actions. In a variation of the present exemplary embodiment, a mix of materials with low friction coefficient in the touch sensitive area and high friction coefficient elsewhere may be used. Such materials are known in the prior art. An example (not limiting the scope of the present innovative solution) is materials similar to rubber and others. In a variation of the present exemplary embodiment elastic glove 1000 may be implemented with more or with less than 6 faces.

FIG. 11 shows an exploded posterior view of a second alternative implementation of the glove of FIGS. 9A-B. Glove 1100 is made up of a 6-faced elastic and flexible glove component 1120, having a whole 1121 along its entire length. Upon component 1120 is an optional force sensitive resistor strip 1127 hidden behind the touch sensitive surface 1125, attached at its frontal face. A low layer housing electronic component in its frontal, posterior, or both faces is inserted either adjacent to surface 1127 or 1123 (light producing surface). Frontal layer 1125 is wired with layer 1127 and 1123. In alternative exemplary embodiments, one or two mid layers (not shown) are inserted to house electronic components, each mid layer below one of surfaces 1123 or 1125. Mid layer(s) are wired with external layers 1123, 1125. The wiring is not shown for visual simplicity. On the inner surface of touch sensitive surface 1125 (i.e. the side touching the brake lever's frontal area) is attached a rubber strip 1130 with higher resistive coefficient that the rest of the sleeve. Its purpose is to prevent the slipping or movement of the sleeve during use and especially during braking.

Components 1123, 1125 are securely attached to each other at their two distant ends; at one end by a pair of flexible battery cell members 1105, 1107 facing each other; at the other end by a metal coil 1140, which also serves the charging function of glove 1100. When not in use, glove 1100 is removed from the hand brake lever and is worn around a coil member of an external charging device, whether a battery-operated charging device or one connected to mains power either directly or via a voltage transformer.

The above components of glove 1100 are also enclosed in an elastic cylindrical component 1101 with a hole 1103 along its length made of an elastic material with a friction coefficient high enough to prevent the glove from moving, twisting, or turning on the handbrake lever during UI or braking actions, and to prevent the rider's hand from slipping during UI and especially during braking actions. Such materials are known in the prior art. An example (not limiting the scope of the present innovative solution) is materials similar to rubber and others.

Glove 1100 may omit the use of the touch sensitive surface 1125 or the light producing surface 1123. This is useful when a rider wants to have all the UI in one hand and visual feedback on both sides of the handlebar. This setup may cut cost as such a user will buy a glove 1100 with visual feedback (or UI) capabilities and a glove 1000 with combined UI and visual feedback capabilities.

Strips 1030, 1130, 1132, 1134 are rubber-like material of high friction coefficient. They are designed to come into contact with the front part of the brake lever. This way when force is applied for braking, the glove doesn't slide off or around the lever. Having high friction material only there helps with installing/uninstalling the glove as by pulling in/out while raising slightly this high friction surface will lower friction between the lever and the glove. This way the glove can slide in/out easily.

In variations of the exemplary embodiments of FIGS. 10-11 the 6-part elastic and flexible glove components 1020, 1120 may be replaced by glove components with less or with more parts.

In the embodiments of FIGS. 7-10, the electronics layer is formed in a flexible or elastic electronics board, or circuits, to withstand the deformation of the glove during wearing on or removing from the handbrake lever.

In an alternative exemplary embodiment, the PCB board carrying the electronics, is split in smaller PCB boards (standard rigid PCB boards, not flexible or elastic) which are wired to each other by means of elastic connections (e.g. non-tensed wires, printed wires with slack on an elastic substrate, or the like) to ensure that the electronics can withstand the deformation of the glove during wearing on or removing from the handbrake lever.

In a further alternative exemplary embodiment, the PCB board is miniaturized so as to reduce its size relative to the length or to the length and width of the glove, so as to allow the PCB board to withstand the deformation of the glove during wearing on or removing from the handbrake lever, without the PCB board having to deform.

The previous exemplary implementations may be modified to exclude the presented touch sensitive surface and the sensor for detecting braking. Such an exemplary embodiment of the invention is a visual feedback device used for presenting visual feedback to the user and optionally to other riders and drivers following or behind the user. The visual feedback device may be used together with any user other interaction device, either an interaction device installed anywhere at the bike or the handbrake lever, or an external device such as a smartphone, smartwatch, etc. The visual feedback module comprises all the elements presented in the previous exemplary embodiments except from the touch sensitive surface (fifth layer 639), the fourth layer 637, and the switch 675 to detect braking action.

UI and Visual Feedback System

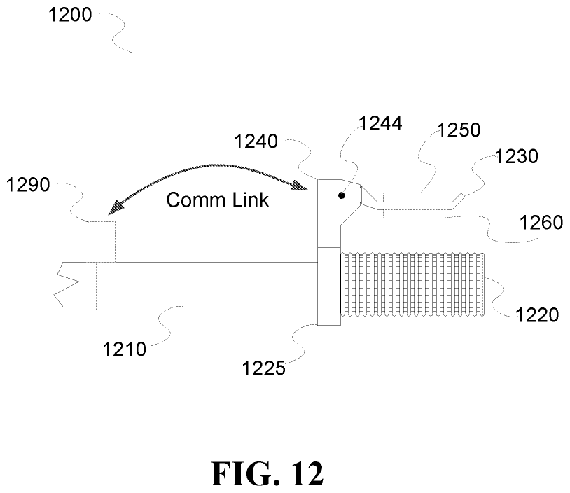

FIG. 12 shows a UI and visual feedback system installed at the handlebar of a two-wheeled vehicle. System 1200 is made up of a handlebar 1210, a hand grip 1220, a hand brake lever 1230, pivoting around pin 1244 attached to a handbrake body part 1240, which is in turn attached to a handlebar 1210 via an attachment part 1225. Lever 1230 has a touch sensitive surface 1250 attached to its frontal face and a light producing surface 1260 attached to its posterior surface. In between surfaces 1260, 1250 is sandwiched a layer housing electronic components which provide interfacing with the elements of surfaces 1260, 1250, and other button-like detector elements that are not shown for simplicity. The electronics of the sandwiched layer also provide a communications interface in the form of a wired or wireless link with an external computing module 1290 which may be attached to any point on handlebar 1210 or any part of the vehicle's frame, stored in a pocket also attached to the vehicle's frame, or worn by the user, carried in a backpack, etc. Communication, is done using any known standard or with a propriety protocol. A common choice is the Bluetooth™ protocol for near distance wireless communication. The processing device 1290 may be an off-the-shelf or custom-made processing unit, a trip computer, an e-bike or motorbike computer, an electronic gear shifter or other bike component, a smartphone, or any other portable device.

In an alternative exemplary embodiment, the electronics inside lever 1230 may also possess sufficient processing power to operate autonomously or to communicate with a processing unit attached to or integrated in handbrake body part 1240. To accommodate operation when no external power is supplied to the electronics in the lever, batteries are installed and connected with the electronics. In an alternative exemplary embodiment, the batteries are connected to a dynamo-module, a mini solar panel, a power bank, or the battery of an e-bike or motorbike for charging. In these exemplary embodiments, the communication with external devices is wireless, while in other embodiments communication is via wire or a combination of the two.

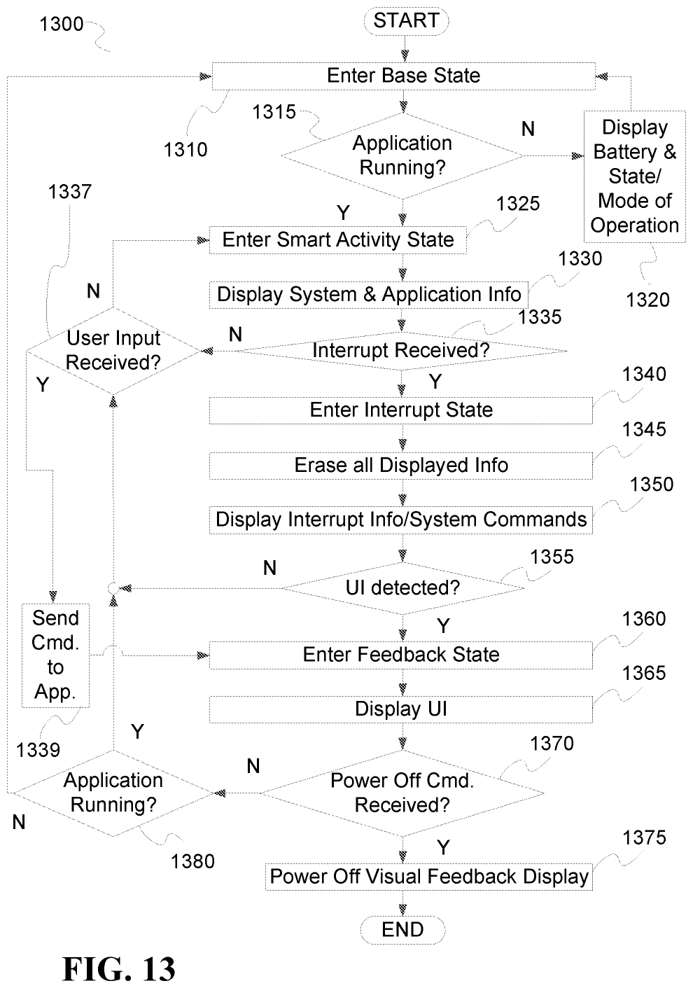

FIG. 13 shows a high-level flowchart with the states of operation of the present innovative UI and visual feedback system. Methodology 1300 contains four states of operation 1310, 1325, 1340, 1360 of the present innovative solution and interconnecting steps. System operation at power-up starts in a first default state, Base State 1310, where the processor connected or integrated with the UI and Feedback module (i.e. the handbrake lever components or glove module and the associated electronics and processor module) waits for system command input. If no application is running 1315 on an external device interfaced via an application Programming Interface with the processor module of the present solution, the processor instructs visual feedback module 260 on the back face of hand brake lever 230 to display the battery power level 1320 of the system (i.e. of the processor module battery, or lever electronics module battery, or e-bike battery if used) and the percentage of power assist for e-bikes, or the state or mode of operation.

If a connected application is running 1315 on an external computing module or device, then the system enters a second state, Smart Activity State 1325, where the processor (a) waits for application or system command input, and (b) displays system information 1330 (and connected application information produced at every new application event). The processor checks if an interrupt signal or a system command has been received 1335. If no interrupt is received then the system stays in smart state 1325.

If an interrupt signal or a system command has been received 1335, the system enters a third state, Interrupt State 1340, where the processor erases all the displayed visual information 1345 displayed at visual feedback module 260. The processor then displays information 1350 related to the interrupt or system command.

The processor then checks if a user interaction has occurred 1355 (i.e. the rider has interacted with the touch sensitive module 250 on the front face of hand brake lever 230 while a braking action is not detected). If no UI is detected (or a UI is detected while braking), then the system stays in smart state 1325.

If a user interaction (while not braking) is detected 1355, then the system enters a fourth state, Feedback State 1360, where the processor instructs visual feedback module 260 on the back face of hand brake lever 230 to display a light pattern 1365 that corresponds to the detected, and interpreted by the processor, UI pattern. This visual feedback is aimed at informing the user of the reception of his UI and ensures that the UI is correctly interpreted. Haptic/Pattern UI and feedback is user defined. A similar operation occurs in smart activity state for predetermined commands for a connected application (e.g. volume-up/down).

The processor then checks if a power-off command has been received 1370 for the UI and visual feedback module. If a power-off command has been received 1370, the processor instructs the visual feedback module to power off 1375 and methodology 1300 ends. If no power-off command has been received, the processor checks if the external device or application is still connected and running 1380. If the external application is not connected 1380, then the system returns to base state 1310, while if the external application is connected 1380, the system returns to smart activity state 1325.

In alternative exemplary embodiments, the application in step 1315 is running at the processor of the present invention or at the electronics of the UI and feedback module; the system also contains haptic feedback to supplement the visual feedback; and the pattern of UI to be detected and the pattern of visual and haptic feedback are defined or adapted by the rider during system setup (and not while riding to avoid accidents).

At step 1335, if no interrupt is received, the system checks of a user input has been received 1337. If no user input is received 1337, then the system enters smart activity state 1325. If a user input is received 1337, then the systems sends the user's command (as it is captured by the touch-sensitive surface and interpreted by the system) to the connected application (or device) 1339 and the system enters feedback state 1360.

The flowchart of FIG. 13 contains only the main states and steps in the operation of the present innovative system. Other states and steps may exist but are not included in the present high-level flowchart. These are in general known to all readers of ordinary skill in related art (electronics, information technology, and software).

### SYSTEM OPERATION EXAMPLE

Examples of actions taking place in the four systems states presented in FIG. 13 are presented below.

### First Example Actions

In a first example, in base state 1310, a white bar on the left or right visual display module 250, 251 represents the remaining battery power percentage of the UI and feedback system.

### Second Example Actions

In a second example, in base state 1310, a white bar on the left visual display module 251 represents the percentage of the power applied to electrical assist mode of an e-bike, while on the right visual display module 250 a white bar of the remaining battery power percentage is displayed. Simultaneous one-finger swipes on both levers could increase/decrease level of assist (i.e. power) if the rider moves his fingers apart or close to each other.

### Third Example Actions

In a third example, in smart activity state 1325, “Maps” and “Music” applications are active on the rider's smart phone, which is carried in his backpack, out of the rider's sight. Maps' touch inputs are assigned to left lever UI surface 251 while Music's inputs are assigned to the right lever UI surface 250 (e.g. swipe to adjust volume, etc.). Maps' navigation information for taking a right or left turn flashes a yellow right or left light bar in the visual feedback modules 260, 261, respectively.

In a variation of the third example, the flashing light bars are replaced by a light bar increasing in length or moving towards the direction that the Maps indicate and so the rider is directed to turn towards this direction.

In yet another variation of the third example, haptic feedback is also used to vibrate the side (left or right) indicated by the visual feedback modules 260, 261 so as to eliminate the need to check the visual feedback modules 260, 261 or to alert the rider to check them.

### Fourth Example Actions

In a fourth example, in interrupt state 1340, the rider's smart phone, stored out of the rider's sight, is connected to the UI and visual feedback system. A call is received at the smart phone, and the “Phone” application (running at the smart phone and being connected to the processor of the UI and visual feedback system's processor), creates an interrupt signal and causes the system to enter interrupt state 1340. A right-moving green bar on the right visual feedback module 260, and a left-moving red bar on the left visual feedback module 261 are displayed. The rider makes a right swipe with any finger on any of the two visual feedback modules 260, 261 to accept the call, or a left swipe to decline it.

### Fifth Example Actions

In a fifth example, in feedback state 1360, whenever the rider makes a recognizable touch pattern on any of touch sensitive modules 250, 251 (e.g. one of the patterns in examples 1-4 above) a similar pattern is displayed on the corresponding visual feedback modules 260, 261. If the user swipes right and the command is accepted (i.e. recognized as a valid command), a bar is displayed swiping right on the correspond visual feedback module 260.

The above examples are only indicative and are not intended to limit the scope of protection and use of the present invention. Modification, addition and deletion of steps etc. can be done without deviating from the scope of the invention.

Example of UI Triggering Visual Feedback

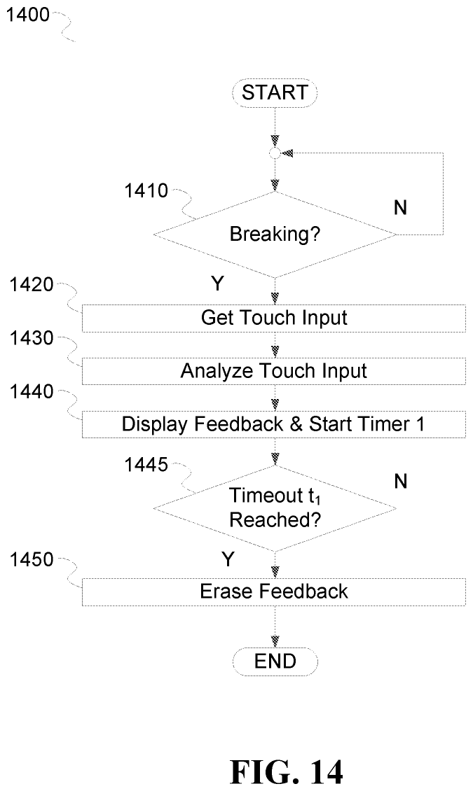

FIG. 14 shows an example flowchart diagram of UI actions triggering visual feedback in system 200. Methodology 1400 starts with the system processor (and/or the local processor at or near hand brake levers 230, 231) checking if a braking action occurs 1410. When braking is no longer detected 1410, the input from touch sensitive modules 250, 251 is read 1420 and analyzed 1430. The analyzed touch input (i.e. rider's UI) triggers an output to be displayed 1440 at the corresponding visual feedback module 260, 261.

The processor starts a timer as soon as it instructs the visual feedback module 260, 261 to display the triggered output 1440 and after the timer reaches a timeout value t₁ 1445, the processor instructs visual feedback module 260, 261 to erase 1450 its display and return to one the four states described in FIG. 13.

Example of Input from External Device or Application triggering Visual Feedback

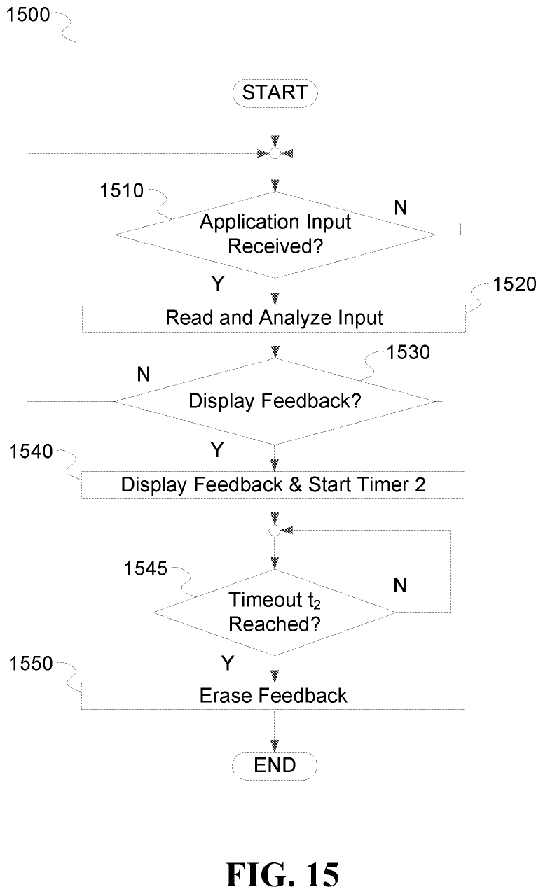

FIG. 15 shows a flowchart diagram of an external device or application feedback triggering visual feedback in system 200. Methodology 1500 starts with the system processor (and/or the local processor at or near hand brake levers 230, 231) checking if input from an external device or an application running at an external device connected to the processor is received 1510. When input is received 1510, the input is read and analyzed 1520. The analyzed input (e.g. indications from “Maps”, an incoming call from “Phone”, or input from other applications) triggers 1530 an output to be displayed 1540 at the corresponding visual feedback module 260, 261. If the input does not trigger 1530 an output to be displayed, the methodology branches back to the first step, i.e. checking for input 1510.

The processor starts a timer as soon as it instructs the visual feedback module 260, 261 to display the triggered output 1540 and after the timer reaches a timeout value t₂ 1545, the processor instructs visual feedback module 260, 261 to erase 1550 its display and revert back to one of four states described at FIG. 13.

Interpretation of User Operation of the UI and Visual Feedback Mechanism

User input at the touch sensitive surface needs to be initially captured and then analyzed before the user's actions (e.g. swipe, etc.) are understood and then trigger associated actions. Initially analogue signals of the touch sensitive elements are captured and digitized by the electronics at the hand brake levers. If a braking action has been detected the digitized inputs are ignored. If no braking action is detected the digitized signals are analyzed either at the electronics in the hand brake lever or at some external processing unit.

By means of example if no fingers touch the touch sensitive (UI) surface 250, 251, placement of any finger can be interpreted as a “tap” if the action is repeated more than once within a predetermined 1^{st} time threshold. If one or more fingers touch the UI surface, a tap action has to be repeated more than once within the first, within a 2^{nd} time threshold. The need to repeat the tap actions is used so as to differentiate between an intended “tap” and an accidental touch event. In a variation of the present exemplary embodiment, taps may also be ignored all together because if the rider is on a bumpy road it might be difficult to avoid repetitive unintentional taps. A solution to this problem is to just ignore taps as an input pattern and use other, more unique input patterns instead (such as swipe, pitch etc.).

Depending of the type of touch sensor, in one exemplary embodiment a resistive sensor can accurately sense 1 finger. In an alternative exemplary embodiment, a capacitive sensor can accurately sense 2 (or more fingers) and thereby support more complex interaction. In yet another exemplary embodiment, a series of matrix sensors arranged back-to-back are used to track each finger.

By means of example and order to detect a swipe right action (e.g. to indicate the intention to turn right or to select an action associated with an external device or application), the electronics analyzing the touch interaction need to track and follow the rider's finger position. The initial position is stored and subsequent positions are tracked. If motion is consistent (i.e. for a swipe to the right, the movement has to be continuous from left to right and not alternating between short left and right motions or interrupted) and within a predefined range of speeds (e.g. v₁ and v₂) then a “swipe right” action is detected.

Other actions can be defined together with ranges and parameters needed to accurately detect them. These definitions can be done by the rider (when not riding his bike) or common default settings can be used. For user definitions, communication with an external computer or smart phone or server is necessary and in particular with an application running at any of these devices. Usually a visual graphical interface is provided by such applications to facilitate operation even by non-computer programmers. The same application can be used to define shortcuts for other commonly used by the rider applications (e.g. music playback applications, navigator application, etc.). Alternatively, these shortcuts are created in the applications they refer to or a combination of both.

Communication and interfacing between the hardware in the handbrake levers or gloves (and in particular with the software [firmware or other] they run) and the external processing units (and the applications, firmware and other software they run) is done using Application Programming Interfaces (APIs) and Software Development Kits (SDK). There is no restriction in the programming languages that are used and thereby any programming language (including high and low level languages, eXtensible Markup Languages [XMLs], etc.) or combination of languages may be used.

For the rider to be able to switch between external devices and applications to interact with, the firmware or application processing the UI on the touch sensitive surface of the hand brake lever communicates with a special application running in the background of the external device. This external application receives UI input and switches between other applications to perform the user intended actions. In an alternative implementation, some or all the functionalities of applications or external devices are integrated in the Operating System (OS) of the external devices. This design may result in the firmware or application processing the UI on the touch sensitive surface of the hand brake lever to communicate directly with the OS of the external devices.

The same mechanism is used to control the visual feedback surface and present indications to the users and/or third parties. In a particular exemplary embodiment, the lever electronics connect to the computer of an e-bike and take power from the vehicle's battery. Battery level and/or remaining time are displayed on the posterior face of the handbrake lever like, for example, a bar showing the corresponding power and/or time level.

In another exemplary embodiment the left UI and visual feedback module is associate with a first external device, while the right with a second external device. In a variation of this exemplary embodiment, the left module is associated with a first application while the right module with a second application. The first and second applications run at the same external device (e.g. the first external device) or the first application runs on the first external device and the second application runs at the second external device or vice versa.

When the UI and visual feedback modules are used in a motorbike no special switch on the hand brake is needed for detecting a braking action. This sensing signal may be supplied by the braking sensor already present in the motorbike and used to switch on and off a brake light at the rear of the motorbike. However, this is true only for the hand brake side of the handlebar and not for the side where the clutch is located.

Example Hardware Architecture

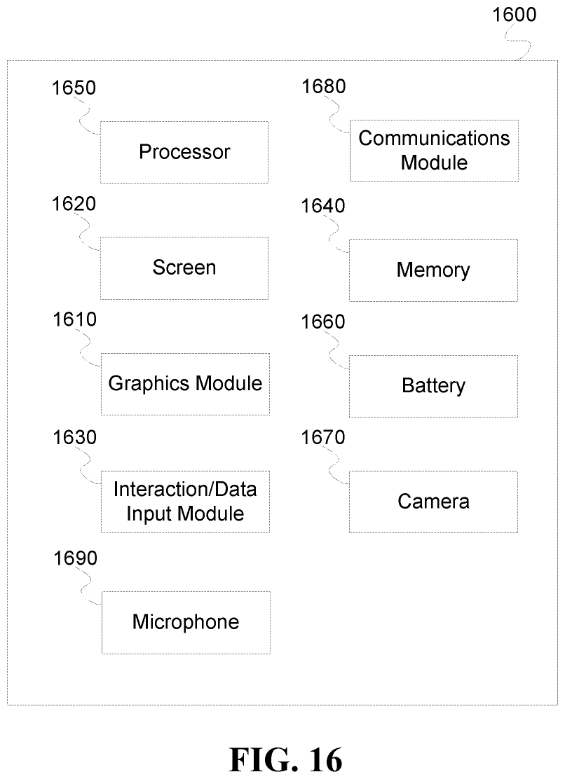

FIG. 16 shows an example architecture of a computing device or apparatus. Such computing device 1600 comprises Processor 1650 upon which Graphics Module 1610, Screen 1620 (in some exemplary embodiments the screen may be omitted), Interaction/Data Input Module 1630, Memory 1640, Battery Module 1660 (in some exemplary embodiments the battery module may be omitted if power is supplied by an external source like an e-bike's main battery module), Camera 1670 (in some exemplary embodiments the camera may be omitted), Communications Module 1680, and Microphone 1690 (in some exemplary embodiments the microphone may be omitted). Sensors modules may optionally be included (e.g. ambient light sensor, magnetic sensor, etc.).

Example Software Architecture

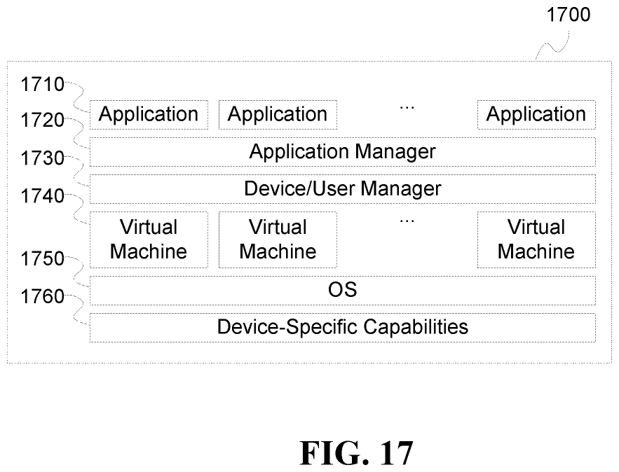

FIG. 17 shows the main Software Components of a device or apparatus. At the lowest layer of software components 1700 are Device-Specific Capabilities 1760, that is the device-specific commands for controlling the various device hardware components. Moving to higher layers lie the Operating System (OS) 1750, Virtual Machines 1740 (like a Java Virtual Machine), Device/User Manager 1730, Application Manager 1720, and at the top layer, Applications 1710. These applications may access, manipulate and display data.

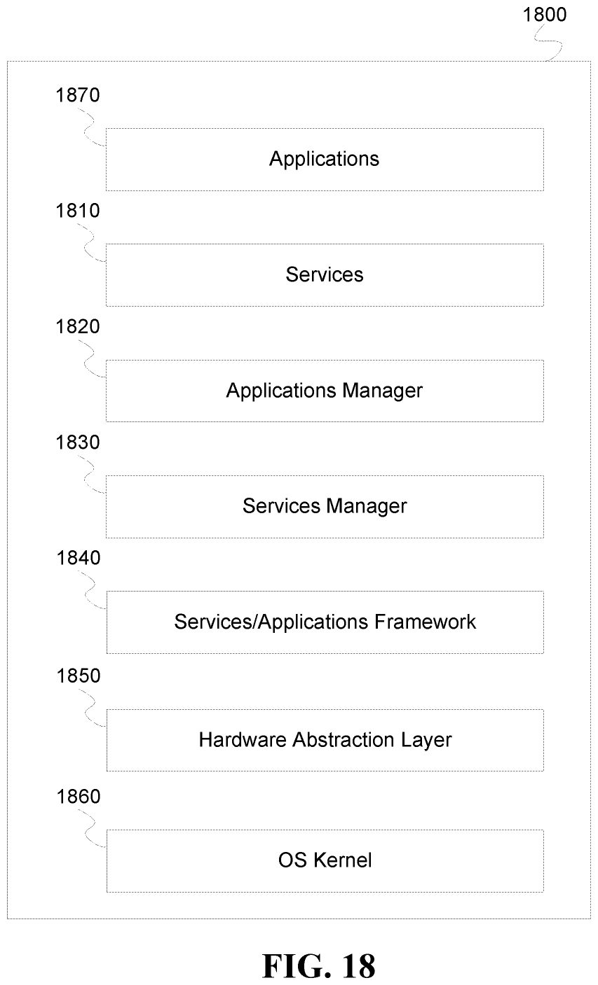

FIG. 18 shows the main Software Components of a Server. At the lowest layer of the software components 1800 is OS Kernel 1860 followed by Hardware Abstraction Layer 1850, Services/Applications Framework 1840, Services Manager 1830, Applications Manager 1820, and Services 1810 and Applications 1870.

It is noted, that the software and hardware components shown in FIGS. 16-18 are by means of example and other components may be present but not shown in these figures, or some of the displayed components may be omitted.

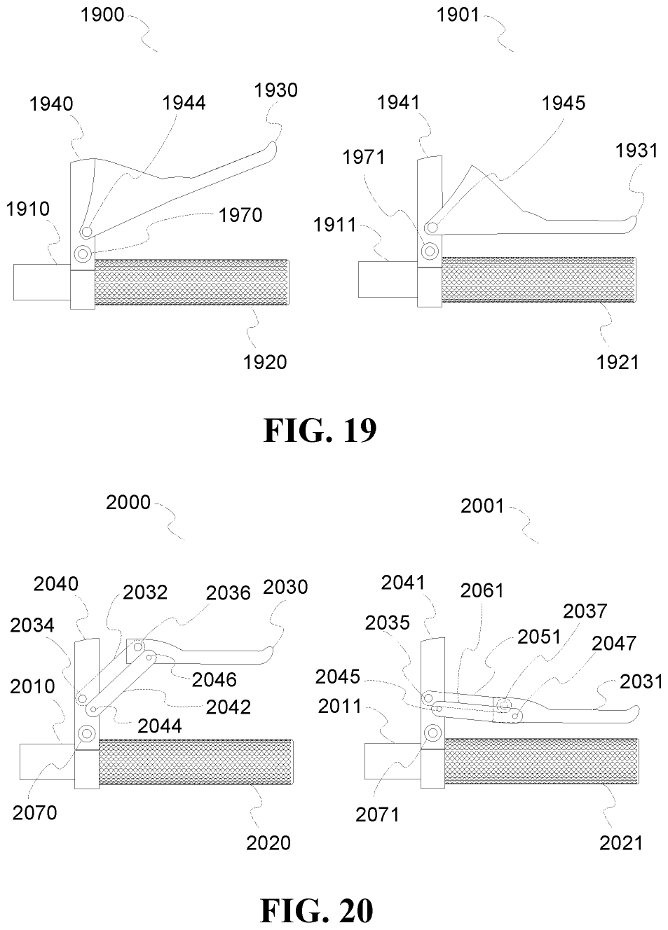

FIG. 19 shows a hand brake lever setup in a non-engaged position and a hand brake lever setup in an engaged position. Hand brake lever setup 1900 is made up of handlebar 1910, mounting part 1940, hand brake lever 1930 pivoting about pin 1944, (optional) button 1970, and handgrip 1920. Lever 1930 is not engaged and at an angle to hand bar 1910 (and handgrip 1920).

Hand brake lever setup 1901 is made up of handlebar 1911, mounting part 1941, hand brake lever 1931 pivoting about pin 1945, (optional) button 1971, and handgrip 1921. Lever 1931 is engaged and parallel with respect to hand bar 1911 (and handgrip 1921).

FIG. 20 shows a hand brake lever setup with double wishbone elements in a non-engaged position and a hand brake lever setup with double wishbone elements in an engaged position. Hand brake lever setup 2000 is made up of handlebar 2010, mounting part 2040, hand brake lever 2030 pivoting about pins 2036, 2046 on two wishbone elements 2032, 2042, which in turn pivot about pins 2034, 2044 on mounting part 2040. Hand brake lever setup 2000 also has a (optional) button 2070, and handgrip 2020. Lever 2030 is not engaged and is parallel with respect to hand bar 2010 (and handgrip 2020).

Hand brake lever setup 2001 is made up of handlebar 2011, mounting part 2041, hand brake lever 2031 pivoting about pins 2037, 2047 on two wishbone elements 2051, 2061, which in turn pivot about pins 2035, 2045 on mounting part 2041. Hand brake lever setup 2001 also has a (optional) button 2071, and handgrip 2021. Lever 2031 is engaged and is parallel with respect to hand bar 2011 (and handgrip 2021). The use of the two wishbones 2032, 2042 (or 2051, 2061) ensures that lever 2030, 2031 is always kept parallel to handlebar 2010, 2011 and handgrip 2020, 2021 for easier operation by the rider.

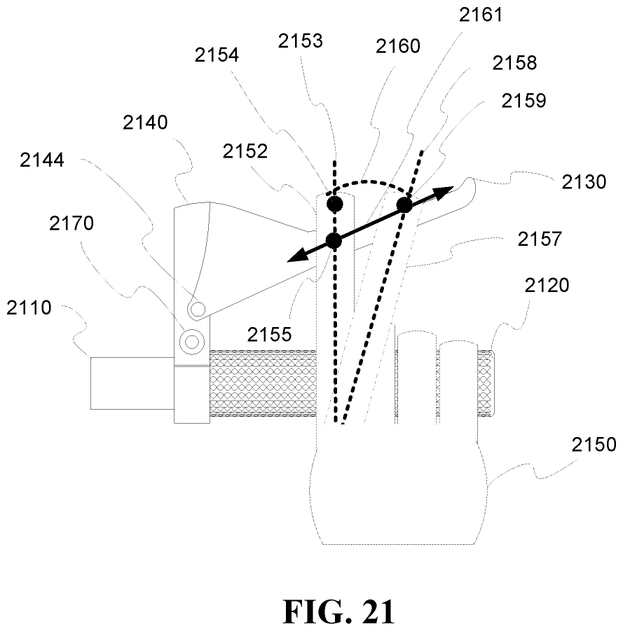

FIG. 21 shows a user's hand operating the present innovative solution on the hand brake setup of FIG. 19. The rider has his hand 2150 placed around handgrip 2120, which is mounted around handlebar 2110. A mounting part 2140 is securely attached on handlebar 2110 and has an optional button 2170 for indicating user input action. Upon mounting part 2140 is attached via pin 2144 a handbrake lever 2130 1(shown in an unengaged position) upon which the rider places his index finger to operating the touch sensitive surface (not shown). The rider is trying to swipe his finger 2152 from a first position 2155 on the touch sensitive surface to a second position 2159 on the same surface. Anatomically, the rider can swipe from a position 2154 (outside the touch sensitive surface) towards position 2159. This is dictated by the axis along the index finger 2152, where at the first position axis 2153 will move to the second position of index finger 2157, axis 2158, and draw an arc 2160. To draw a linear path from position 2155 to position 2159 the driver has to deflect his index finger and make a conscious effort to do so. Such effort may result in discomfort, fatigue and, up to a certain degree, distract his attention from the riding environment.

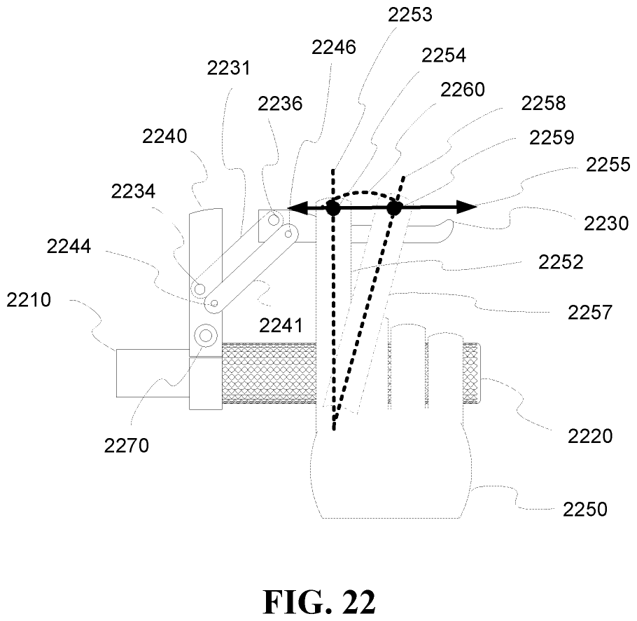

FIG. 22 shows a user's hand operating the present innovative solution on the hand brake setup of FIG. 20. The rider has his hand 2250 placed around handgrip 2220, which is mounted around handlebar 2210. A mounting part 2240 is securely attached on handlebar 2210 and has an optional button 2270 for indicating user input action. Upon mounting part 2240 are attached via pins 2234, 2244 two wishbone members 2231, 2241 and upon the two wishbone members 2231, 2241 is attached a handbrake lever 2230 upon which the rider places his index finger to operate the touch sensitive surface (not shown). Hand brake lever 2230 is kept parallel to handlebar 2210 and handgrip 2220 both when engaged and when non-engaged.

The rider is trying to swipe his finger 2252 from a first position 2254 on the touch sensitive surface to a second position 2259 on the same surface. Anatomically, the rider can swipe from position 2254 towards position 2259 (both on the touch sensitive surface). This is dictated by the axis along the index finger 2252, where at the first position axis 2253 will move to the second position of index finger 2257, axis 2258, and draw an arc 2260. To draw a linear path 2255 from position 2254 to position 2259 the driver simply has to slide his index finger on the touch sensitive surface. Arc 2260 and linear path 2255 are closely matching one another and since they do not require the rider to move his finger at any uncomfortable angle to its normal motion, the rider is not distracted and his finger is not experiencing any discomfort (as opposed to the standard setup without the double wishbone design. In an alternative embodiment, the wishbone elements 2231, 2241 could have slightly different lengths and the positioning of pins 2234, 2244, 2236, 2246 could be slightly offset in order to allow different positioning of the brake lever 2230 in the engaged and/or the non-engaged position. For example, lever 2230 could be parallel to handlebar 2210 at the non-engaged position but have a slight inner-leaning angle at the engaged position so as to prevent the rider's fingers from sliding outwards during braking.

In all the exemplary embodiments presented above, the touch sensitive surface may be placed on the frontal surface of the (single or double-double wishbone) handbrake lever, or on its upper-frontal surface, or on its upper surface.

The present innovative solution can also be implemented by software written in any programming language, or in an abstract language (e.g. a metadata-based description which is then interpreted by a software or hardware component). The software running in the above-mentioned hardware, effectively transforms a general-purpose or a special-purpose hardware or computing device, apparatus or system into one that specifically implements the present innovative solution.

Alternatively, the present innovative solution can be implemented in Application Specific Integrated Circuits (ASIC) or other hardware technology.

In alternative exemplary embodiments the UI and visual feedback module in the handbrake lever communicates (either directly or via some external processing unit) with remote servers which provide UI and data for display in the posterior surface of the lever.

The above exemplary embodiment contains a large number of components. Among these components the following are essential for the operation of the present innovative solution for each embodiment presented earlier:
(i) touch sensitive surface, optional sensor for detecting braking, and electronics layer for digitizing and interpreting user input, and for communicating with external devices, all attached to a bike handbrake lever
(ii) touch sensitive surface, light emitting surface, sensor for detecting braking, and electronics layer for digitizing and interpreting user input, and for communicating with external devices, all attached to a bike handbrake lever
(iii) a bike handbrake lever with integrated touch sensitive surface, sensor for detecting braking, and electronics layer for digitizing and interpreting user input, and for communicating with external devices
(iv) a bike handbrake lever with integrated touch sensitive surface, light emitting surface, sensor for detecting braking, and electronics layer for digitizing and interpreting user input, and for communicating with external devices
(v) an elastic glove to be worn on a bike handbrake lever, containing a touch sensitive surface, an optional sensor for detecting braking, and an electronics layer for digitizing and interpreting user input, and for communicating with external devices,
(vi) an elastic glove to be worn on a bike handbrake lever, containing a touch sensitive surface, a light emitting surface, a sensor for detecting braking, and an electronics layer for digitizing and interpreting user input, for displaying visual information to the light emitting surface and for communicating with external devices,
(vii) glove similar to (v) or (vi) with connector for charging.
   In certain variations of the exemplary embodiments, the light producing surfaces are optional and the innovative solution is used only for accepting user input and in some embodiments also for haptic feedback. The remaining components are optional and may be omitted or substituted by others.

The above exemplary embodiment descriptions are simplified and do not include hardware and software elements that are used in the embodiments but are not part of the current invention, are not needed for the understanding of the embodiments, and are obvious to any user of ordinary skill in related art. Furthermore, variations of the described system architecture are possible, where, for instance, some servers may be omitted or others added.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive or limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

In one or more exemplary embodiments, the functions described may be implemented in hardware, software, firmware, or any combination thereof. If implemented in software, the functions may be stored on or transmitted over as one or more instructions or code on a computer readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A user interaction device for use in a bike, the user interaction device comprising:
a touch sensitive surface for capturing a user input without distracting a user of the user interaction device, where the touch sensitive surface is attached to one of (a) a frontal face, (b) an upper face, and (c) between the frontal face and the upper face of a handbrake lever of the bike;
at least one electronics module connected to the touch sensitive surface for digitizing the user input and for communicating with at least one of (a) an external computing module and (b) an external device; and
a power module connected with at least the touch sensitive surface and the at least one electronics module for providing power.

2. The user interaction device of claim 1, further comprising at least one sensor for detecting pressing action on the handbrake lever, where the sensor for detecting pressing action on the handbrake lever is connected with at least the at least one electronics module.

3. The user interaction device of claim 1, further comprising a haptic feedback device connected with at least the at least one electronics module.

4. The user interaction device of claim 1, further comprising:
a light emitting surface for displaying visual information, where the light emitting surface is attached to one of (a) a posterior face of the handbrake lever, (b) the upper face of the handbrake lever, and (c) between the posterior face and the upper face of the handbrake lever; and
where at least one of the at least one electronics module is configured for presenting the visual information on the light emitting surface, and where when the light emitting surface and the touch sensitive surface are both positioned at the upper face of the handbrake lever, the light emitting surface and the touch sensitive surface are configured for one of (a) positioning proximal to each other at the upper face of the handbrake lever and (b) together as a touch screen.

5. The user interaction device of claim 1, where (a) the touch sensitive surface is selected from a set comprising a capacitive surface, a set of touch sensitive surfaces positioned next to each other along the length of the lever, a matrix selected from a set comprising a capacitive matrix of elements, a piezoelectric matrix of elements, at least one optical element, and a touch screen, and (b) the at least one electronics module comprises a processing unit and at least one memory unit.

6. The user interaction device of claim 2, where the at least one sensor is selected from a set comprising (a) a magnetic sensor, (b) an electromagnetic sensor, (c) a capacitive element, (d) a resistive element, (e) a piezoelectric element, (f) a force sensitive resistor, (g) an optical sensor, (h) an ultrasonic sensor, (i) a mini radar, (j) the touch sensitive surface which detects pressing action by detecting a pressure exceeding a threshold, (k) a push button, (l) a force sensing element, and (m) a stress sensing element.

7. The user interaction device of claim 3, where the haptic feedback device is selected from a set comprising a cam motor, and a linear mass actuator.

8. The user interaction device of claim 4, where the light emitting surface is selected from a set comprising a light emitting diode matrix, a light emitting strip, a matrix of miniature incandescent light bulbs, a flat screen and a curved screen.

9. The user interaction device of claim 1, where the user interaction device is configured as a sandwich of layers, to comprise in the following order of attachment (a) the touch sensitive surface, (b) a first support layer, and (c) a Printed Circuit Board (PCB) layer housing the at least one electronics module, where the user interaction device is configured for one of (i) attachment at the frontal face of the handbrake lever with the PCB layer facing the handbrake lever, and (ii) sandwiching in a gap running along a length of the handbrake lever where at least the first support layer is dimensioned to fit in the gap and at least one of the touch sensitive surface and the PCB board is longer than the gap for fixing the sandwich on the handbrake lever, and the touch sensitive surface is directioned towards the front of the bike.

10. The user interaction device of claim 1, where the user interaction device is configured as an elastic glove-like device for wearing on and removing from the handbrake lever, comprising:
a frontal surface for attaching the touch sensitive surface on top of the at least one electronics module, where at least the touch sensitive surface is configured to withstand deformations during wearing and removing the glove-like device on the handbrake lever;
an energy storage module;
a charging module; and
a back surface in contact with the handbrake lever, comprising a rubber strip of higher friction coefficient compared to a friction coefficient of the glove-like device.

11. The user interaction device of claim 10, where:
the energy storage module is a pair of flexible battery cell members facing each other and positioned at one end of the elastic glove-like device for securely attaching at the one end of the touch sensitive surface and the electronics module; and
the charging module is a metal coil positioned at another end of the elastic glove-like device for securely attaching at the other end of the touch sensitive surface and the electronics module, where the metal coil is also used for charging the elastic glove-like device.

12. The user interaction device of claim 4, where the user interaction device is configured as a sandwich of layers to comprise in the following order of attachment (a) the touch sensitive surface, (b) a first support layer, (c) a Printed Circuit Board (PCB) layer housing the at least one electronics module, (d) a second support layer, and (e) the light emitting surface, where the user interaction device is configured for one of (i) attachment at the frontal face of the handbrake lever with the PCB layer facing the handbrake lever, and (ii) sandwiching in a gap running along a length of the handbrake lever where at least the first support layer is dimensioned to fit in the gap and at least one of the touch sensitive surface and the light emitting surface is longer than the gap for fixing the sandwich on the handbrake lever, and the touch sensitive surface is directioned towards the front of the bike.

13. The user interaction device of claim 4, where the user interaction device is configured as an elastic glove-like device for wearing on and removing from the handbrake lever, comprising:
a frontal surface for attaching the touch sensitive surface on top of the at least one electronics module, where at least the touch sensitive surface is configured to withstand deformations during wearing and removing the glove-like device on the handbrake lever;
a posterior surface for attaching the light emitting surface, where the light emitting surface is configured to withstand deformations during wearing and removing the glove-like device on the handbrake lever;
an energy storage module;
a charging module; and
a back surface in contact with the handbrake lever comprising a rubber strip of higher friction coefficient compared to a friction coefficient of the glove-like device.

14. The user interaction device of claim 13, where:
the energy storage module is a pair of flexible battery cell members facing each other and positioned at one end of the elastic glove-like device for securely attaching at the one end of the touch sensitive surface and the electronics module; and
the charging module is a metal coil positioned at another end of the elastic glove-like device for securely attaching at the other end of the touch sensitive surface and the electronics module, where the metal coil is also used for charging the elastic glove-like device.

15. A visual feedback device configured for use in a bike, the visual feedback device comprising:
a light emitting surface for displaying visual feedback, where the light emitting surface is attached on one of (a) the posterior surface of the handbrake lever, (b) the upper face of the handbrake lever, and (c) between the posterior face and the upper face of the handbrake lever of the bike;
at least one electronics module connected to the light emitting surface for presenting visual information on the light emitting surface, and for communicating with at least one of (a) an external computing module and (b) an external device; and
a power module connected with at least the light emitting surface, and the at least one electronics module for providing power.

16. The visual feedback device of claim 15, further comprising at least one of (a) at least one sensor for detecting pressing action on the handbrake lever, and (b) a haptic feedback device, where the sensor for detecting pressing action on the handbrake lever and the haptic feedback device are each connected with at least the at least one electronics module.

17. The visual feedback device of claim 16 where:
the at least one sensor is selected from a set comprising (a) a magnetic sensor, (b) an electromagnetic sensor, (c) a capacitive element, (d) a resistive element, (e) a piezoelectric element, (f) a force sensitive resistor, (g) an optical sensor, (h) an ultrasonic sensor, (i) a mini radar, (j) a touch sensitive surface which detects pressing action by detecting pressure exceeding a threshold, (k) a push button, (l) a force sensing element, and (m) a stress sensing element; and
the at least one electronics module comprises a processing unit and at least one memory unit.

18. The visual feedback device of claim 16 where the haptic feedback device is selected from a set comprising a cam motor, and a linear mass actuator; and
the at least one electronics module comprises a processing unit and at least one memory unit.

19. The visual feedback device of claim 15, where:
the light emitting surface is selected from a set comprising a light emitting diode matrix, a light emitting strip, a matrix of miniature incandescent light bulbs, a flat screen and a curved screen; and
the at least one electronics module comprises a processing unit and at least one memory unit.

20. The visual feedback device of claim 15, where the visual feedback device is configured as a sandwich of layers, to comprise in the following order of attachment (a) the light emitting surface, (b) a second support layer, and (c) a PCB layer housing the at least one electronics module, where the visual feedback device is configured for one of (i) attachment at the posterior face of the handbrake lever with the PCB layer facing the handbrake lever, and (ii) sandwiching in a gap running along a length of the handbrake lever where at least the first support layer is dimensioned to fit in the gap and at least one of the light emitting surface and the PCB board is longer than the gap for fixing the sandwich on the handbrake lever, and the light emitting surface is directioned towards the back of the bike.

21. The visual feedback device of claim 15, where the visual feedback device is configured as an elastic glove-like device for wearing on and removing from the handbrake lever, comprising:
a posterior surface for attaching the light emitting surface on top of the at least one electronics module, where at least the light emitting surface is configured to withstand deformations during wearing and removing the glove-like device on the handbrake lever;
an energy storage module;
a charging module; and
a back surface in contact with the handbrake lever, comprising a rubber strip of higher friction coefficient compared to a friction coefficient of the glove-like device.

22. The visual feedback device of claim 21, where:
the energy storage module is a pair of flexible battery cell members facing each other and positioned at one end of the elastic glove-like device for securely attaching at the one end of the touch sensitive surface and the electronics module; and
the charging module is a metal coil positioned at another end of the elastic glove-like device for securely attaching at the other end of the touch sensitive surface and the electronics module, where the metal coil is also used for charging the elastic glove-like device.

23. A non-transitory computer program product that causes a user interaction device configured for use in a bike to capture and use a user touch input without distracting a user of the user interaction device, the computer program product having instructions to cause:
a touch sensitive surface to capture a user input, where the touch sensitive surface is attached to one of (a) a frontal face, (b) an upper face, and (c) between the frontal face and the upper face of a handbrake lever of the bike; and
at least one electronics module, connected with at least the touch sensitive surface, to digitize and interpret the user input, and communicate with at least one of (a) an external computing module and (b) an external device.

24. The non-transitory computer program product of claim 23, where the at least one electronics module is further connected with a sensor for detecting pressing action.

25. The non-transitory computer program product of claim 23, further comprising instructions to cause:
a light emitting surface to display a visual feedback, where the light emitting surface is attached on one of (a) a posterior face of the handbrake lever, (b) the upper face of the handbrake lever, and (c) between the posterior face and the upper face of the handbrake lever; and
the at least one electronics module to present visual information on the light emitting surface.

26. The non-transitory computer program product of claim 23, further comprising instructions to cause a haptic feedback unit to provide haptic feedback, where the haptic feedback unit is selected from a set comprising a cam motor and a linear mass actuator.

27. A method of detecting, analyzing, and using a user touch input at a user interaction device of a bike, the method comprising:
detecting a user input at a touch sensitive surface, where the touch sensitive surface is attached to one of (a) a frontal face, (b) an upper face, and (c) between the frontal face and the upper face of a handbrake lever of the bike;
analyzing the user input with at least one electronics module connected with at least the touch sensitive surface, where the analyzing step comprises at least one of (a) using a sensor for detecting pressing action, and (b) ignoring the touch input if pressing action is detected;
identifying and ignoring random user inputs with the at least one electronics module; and
displaying a visual feedback at a light emitting surface, where the light emitting surface is connected at least with the at least one electronics module and is attached on one of (a) a posterior face of the handbrake lever, (b) the upper face of the handbrake lever, and (c) between the posterior face and the upper face of the handbrake lever of the handbrake lever.

28. The method of claim 27, the method further comprising:
starting a timer; and
erasing the visual feedback from the light emitting surface when the timer has reached a timeout.

29. The method of claim 27, where the user input is received at the at least one electronics module from an application running at one of (a) an external computing module, and (b) an external device communicating with the at least one electronics module.
